(19) United States
(12) Patent Application Publication
(10) Pub. No.: US 2025/0103423 A1
(43) Pub. Date: Mar. 27, 2025

(54) ONLINE SOFTWARE PLATFORM (OSP) MONITORING RECENT DATA OF USER FOR A DOMAIN, AND REACTING TO DISCONTINUITY OF THE RECENT DATA FROM HISTORICAL DATA OF THE USER FOR THE DOMAIN

(71) Applicant: Avalara, Inc., Seattle, WA (US)

(72) Inventor: Naveen Kumar AGRAWAL, Bellevue, WA (US)

(73) Assignee: Avalara, Inc., Seattle, WA (US)

(21) Appl. No.: 18/899,331

(22) Filed: Sep. 27, 2024

Related U.S. Application Data
(60) Provisional application No. 63/585,709, filed on Sep. 27, 2023.

(51) Int. Cl. G06F 11/07

(52) U.S. Cl. CPC G06F 11/0793; G06F 11/0784

(57) ABSTRACT

A method performed by a computer system of an online software platform (OSP). The method includes receiving, via a network, a first set of datasets of relationship instances that are associated with a domain from a plurality of domains and a first time period, identifying patterns in the first set of datasets with respect to one or more monitored parameters, receiving, via the network, a second set of datasets of relationship instances that are associated with an entity, the domain, and a second time period that comes after the first time period, determining whether a discontinuity exists in the second set of datasets with respect to the one or more monitored parameters based on comparing values corresponding to the one or more monitored parameters in the second set of datasets against the patterns, and performing a reactive action responsive to determining that the discontinuity exists.

### CROSS-REFERENCE TO RELATED APPLICATIONS

This application claims the benefit of U.S. Provisional Application No. 63/585,709, filed Sep. 27, 2023, which is hereby incorporated by reference.

This application is also related to International Application No. [TBD], filed the same day, which also claims priority to U.S. Provisional Application No. 63/585,709, filed Sep. 27, 2023, which is hereby incorporated by reference.

### TECHNICAL FIELD

Embodiments of the invention relate to the field of online software platforms (OSPs), and more specifically, to monitoring datasets of relationship instances for discontinuities with respect to monitored parameters.

### BACKGROUND

An online software platform (OSPs) may receive datasets from a user of the OSP over a network and perform actions (e.g., computations) on the datasets that are useful to the user. Each dataset may represent a particular instance of a relationship between a primary entity and a secondary entity, and indicate aspects of that relationship instance. For example, the dataset of a relationship instance may include a numerical base value for the relationship instance and possibly other values indicating other aspects of the relationship instance. Each relationship instance may be associated with a domain that has domain rules (e.g., due to the primary entity and/or the secondary entity associated with the relationship instance being at least partially geographically located within the geographic boundaries of the domain or otherwise being associated with the domain). The OSP may maintain digital rules that correspond to the domain rules of a domain. Responsive to receiving a dataset of a relationship instance, the OSP may produce a resource for the relationship instance based on applying one or more digital rules of the domain associated with the relationship instance to the base value for the relationship instance. The OSP may then transmit a notification regarding the produced resource to the user of the OSP.

A dataset may have parameters that can also be called dataset parameters. Each dataset parameter may represent a particular aspect of a relationship instance. At least some of the dataset parameters of a dataset may have respective values that can also be called dataset values. Each dataset value may indicate the particular aspect of a relationship instance represented by the corresponding dataset parameter.

### SUMMARY

The present disclosure is about instances of computer systems, storage media that may store programs, and methods.

As mentioned above, an online software platform (OSPs) may receive datasets from a user of the OSP over a network and perform actions (e.g., computations) on the datasets that are useful to the user. Each dataset may represent a particular relationship instance. For datasets of relationship instances associated with the same entity and domain, the dataset values of certain dataset parameters are expected to stay consistent or follow a certain pattern over time. A sudden or large change in the dataset values of the certain dataset parameters or a sudden or large deviation from a historical pattern could indicate that there was an error in how the datasets were prepared or that the digital rules maintained by the OSP do not reflect the current domain rules of the domain. Embodiments are disclosed herein that can monitor datasets of relationship instances for discontinuities and react to any discontinuities that exist in those datasets.

According to some embodiments, a computer system of an OSP receives, via a network, a first set of datasets of relationship instances that are associated with a domain from a plurality of domains and a first time period. The computer system may then identify patterns in the first set of datasets with respect to one or more monitored parameters. The OSP may allow a user of the OSP to configure the parameters that the OSP should monitor, as desired. The patterns may include statistics for a monitored parameter such as a mode value (the most commonly appearing value) for the monitored parameter, an average value for the monitored parameter, a standard deviation for the monitored parameter, a percentage of datasets in which the monitored parameter has a particular value, a percentage of datasets in which the monitored parameter has a particular value when a description parameter has a particular description value, and/or a trend of values (e.g., values increase or decrease by a certain percentage every time period) for the monitored parameter. The computer system may then receive, via the network, a second set of datasets of relationship instances that are associated with a particular entity, the domain, and a second time period that comes after the first time period. The computer system may produce a resource based on applying one or more of the digital rules of the domain to values included in the second set of datasets and transmit a notification regarding the produced resource to an agent of the entity. The computer system may also determine whether a discontinuity exists in the second set of datasets with respect to the one or more monitored parameters based on comparing values corresponding to the one or more monitored parameters in the second set of datasets against the patterns. Responsive to determining that the discontinuity exists in the second set of datasets with respect to the one or more parameters, the computer system may perform a reactive action that involves an aspect associated with the entity or the second set of datasets. The reactive action may include transmitting a notification regarding the discontinuity to an agent of the entity, generating a processing error for a dataset included in the second set of datasets, logging information regarding the discontinuity for viewing by an agent of the entity, and/or modifying a dataset included in the second set of datasets (to what is considered to be the correct value or the value that is consistent with historical patterns). The OSP may allow a user of the OSP to configure the reactive action that the OSP should perform when a discontinuity is detected, as desired. In an embodiment, the computer system refrains from performing a reactive action even when a discontinuity exists in the second set of datasets if it is determined that the discontinuity is pervasive (e.g., the discontinuity affects a majority of datasets), as this may indicate that the discontinuity is legitimate, expected, and/or due to an intentional action (e.g., due to a change in the way in which the entity prepares datasets). In an embodiment, the reactive action includes determining whether the domain rules of the domain have changed and responsive to determining that the domain rules of the domain have changed, the computer system updates the corresponding digital rules of the domain maintained by the OSP to reflect the current domain rules.

An advantage provided by embodiments is that they allow the OSP to quickly detect and react to discontinuities that exist in received datasets in real time (e.g., as datasets are being received over a network and being processed). A discontinuity may indicate that there was an error in how the received datasets were prepared or that the digital rules of the domain maintained by the OSP do not reflect the current domain rules of the domain. By being able to automatically and quickly detect discontinuities in received datasets, embodiments may allow for more quickly addressing/fixing any misconfigurations in a timely manner (e.g., change how the datasets are being prepared or update the digital domain rules maintained by the OSP so that they reflect the current domain rules of the domain).

These and other features and advantages of the claimed invention will become more readily apparent in view of the embodiments described and illustrated in this specification, namely in this written specification and the associated drawings.

### BRIEF DESCRIPTION OF THE DRAWINGS

The invention may best be understood by referring to the following description and accompanying drawings that are used to illustrate embodiments of the invention. In the drawings:

FIG. 1 is a diagram showing a sample computer system, according to some embodiments.

FIG. 2 is a diagram showing operations performed by an OSP for monitoring for discontinuities, according to some embodiments.

FIG. 3 is a diagram showing an example of identifying patterns in historical datasets, according to some embodiments.

FIG. 4 is a diagram showing an example of determining that a discontinuity exists in received datasets, according to some embodiments.

FIG. 5 is a diagram showing an example of determining that a discontinuity exists in received datasets but not transmitting a notification because the discontinuity is pervasive, according to some embodiments.

FIG. 6 is a diagram showing a sample UI shown on a screen, according to some embodiments.

FIG. 7 is a flowchart for a method to monitor for discontinuities in datasets, according to some embodiments.

FIG. 8 is a diagram showing details of a sample computer systems, according to some embodiments.

FIG. 9 is a diagram showing an operational example where a buy-sell transaction is a use case of the relationship instance, according to some embodiments.

FIG. 10 is a diagram showing an example of identifying patterns in historical datasets, in a use case where the datasets represent buy-sell transactions, according to some embodiments.

FIG. 11 is a diagram showing an example of determining that a discontinuity exists in received datasets, in a use case where the datasets represent buy-sell transactions, according to some embodiments.

FIG. 12 is a diagram showing an example of determining that a discontinuity exists in received datasets but not transmitting a notification because the discontinuity is pervasive, in a use case where the datasets represent buy-sell transactions, according to some embodiments.

FIG. 13 is a diagram showing a sample UI shown on a screen, according to some embodiments.

FIG. 14 is a flowchart for a method to monitor for discontinuities in datasets, in a use case where the datasets represent buy-sell transactions, according to some embodiments.

### DETAILED DESCRIPTION

The present disclosure is about computer systems, storage media that may store programs, and methods.

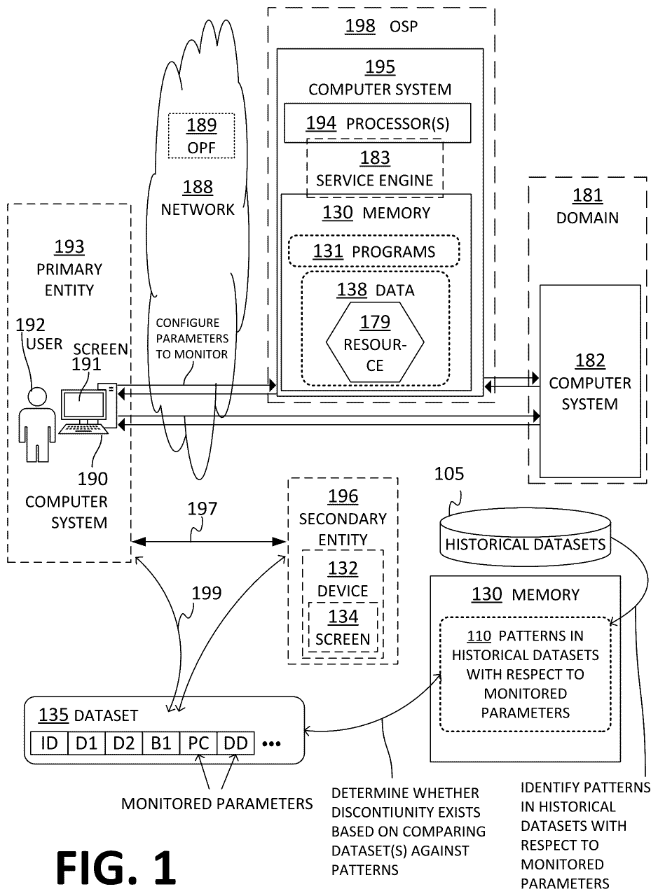

FIG. 1 is a diagram showing a sample computer system, according to some embodiments.

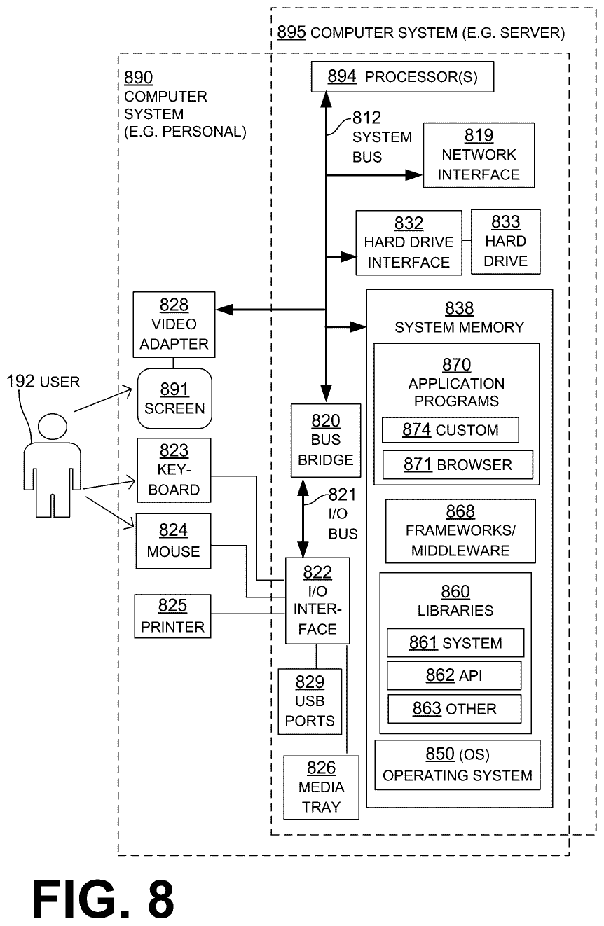

The computer system 195 has one or more processors 194 and a memory 130. The memory 130 may store programs 131 and data 138. An element of the data 138 is a resource 179 that is produced as described later in this document. The one or more processors 194 and the memory 130 of the computer system 195 may implement a service engine 183. Additional optional implementation details for the computer system 195 may be those shown and described later in this document for FIG. 8.

The computer system 195 can be located in “the cloud.” In fact, the computer system 195 may optionally be implemented as part of an Online Software Platform (OSP) 198. The computer system 195 can be configured to perform one or more predefined services on behalf of users, for example via operations of the service engine 183. Such services can be searches, determinations, computations, verifications, notifications, the transmission of specialized information, including data that effectuates payments, the production of resources, the generation and transmission of documents, the online accessing of other systems to effect registrations, and so on, including what is described in this document. Producing the resource 179 can be part of one of these services. Also, the computer system 195 may be configured to perform a discontinuity monitoring service on behalf of users, as described in this document. Such services can be provided in the form of Software as a Service (SaaS). The OSP 198 may be operated and managed by an online service provider.

A computer system 182 can be part of a domain 181. The domain 181 may be defined by geographic boundaries, political boundaries, commercial boundaries, or the like. In an embodiment, the domain 181 can be an organization.

A user 192 may be standalone. The user 192 may use a computer system 190 that has a screen 191, on which user interfaces (UIs) may be shown. In embodiments, the user 192 and the computer system 190 are considered part of a primary entity 193, which could be an organization, an institution, a person, and so on. In such instances, the user 192 may be an agent of the primary entity 193, and even within a physical site of the primary entity 193, although that is not necessary. In embodiments, the computer system 190 or other device of the user 192 can be client devices for the computer system 195. The user 192 or the primary entity 193 may be users of the OSP 198. For instance, the user 192 may use the computer system 190 to log into the computer system 195 or OSP 198 by using credentials, such as a user name, a password, a token, and so on.

The computer system 190 may access the computer system 195 via a communications network 188, such as the internet. In particular, the entities and associated systems of FIG. 1 may communicate via physical and logical channels of the communications network 188. Accordingly, from certain perspectives, the OSP 198 is in the cloud.

Similarly, the computer system 190 may access the computer system 182 via a communications network 188, such as the internet. Accordingly, from certain perspectives, the computer system 182 is in the cloud. In some instances, the computer system 195 may access the computer system 182 on behalf of the primary entity 193.

Moreover, in some embodiments, data from the computer system 190, from the computer system 182, and/or from the computer system 195 may be stored in an Online Processing Facility (OPF) 189 that can run software applications, perform operations, and so on. In such embodiments, requests and responses may be exchanged with the OPF 189, downloading or uploading may involve the OPF 189, and so on. In such embodiments, the computer system 190 and any devices of the OPF 189 can be considered to be remote devices, at least from the perspective of the computer system 195.

Accessing, downloading and/or uploading, and so on may be permitted among these computer systems. Such can be performed, for instance, with manually uploading files, like spreadsheet files, etc. The computer system 190, the computer system 195, the computer system 182, and possibly also the OPF 189, may exchange requests and responses with each other. Such can be implemented with a number of architectures.

In embodiments, the user 192 and/or the primary entity 193 have instances of relationships with secondary entities. For sake of simplicity, only one such secondary entity 196 is shown in the diagram, but it should be appreciated that there can be more than one such secondary entity. The secondary entity 196 may be an organization, an institution, a person, and so on. In some embodiments, the secondary entity 196 has a device 132, which can be an electronic device such as a cellphone, tablet, laptop, computer system, and so on. The device 132 may have a screen 134.

In the example shown in the diagram, the primary entity 193 has a relationship instance 197 with the secondary entity 196. The secondary entity 196 may have used a device such as the device 132 to create the relationship instance 197. The primary entity 193 and/or the secondary entity 196 may be referred to simply as entities.

In some instances, the user 192 and/or the primary entity 193 obtains data about one or more secondary entities, for example as necessary for conducting the relationship instances with them. The obtained data can be about attributes of the entities or aspects of the relationship instances

In embodiments, the computer system 195 receives one or more datasets. Each dataset may represent a particular relationship instance and indicate aspects of that particular relationship instance. A sample received dataset 135 is shown. The received dataset 135 may indicate aspects of the relationship instance 197. The dataset 135 may be received by the computer system 195 in a number of ways. In some embodiments, one or more requests may be received by the computer system 195 via a network 188. The received one or more requests can carry payloads that encode datasets of relationship instances between the primary entity 193 and the secondary entity 196 (and possibly other secondary entities). In such embodiments, the one or more payloads may be parsed by the computer system 195 to extract the dataset 135.

In embodiments, the dataset 135 has parameters that can also be called dataset parameters. At least some of the dataset parameters may have respective values that can also be called dataset values. The dataset values may be numerical, alphanumeric, Boolean, and so on, as needed for what the parameters represent. As an example, the dataset 135 shown in the diagram has an identifier (ID) parameter, a D1 parameter, a D2 parameter, a B1 parameter, a PC parameter, and a DD parameter, among other possible parameters. The value of the ID parameter may be an identifier of the dataset 135 (e.g., an arbitrary or sequential number assigned to the dataset), so as to differentiate it from other such datasets. At least one of the dataset values may indicate an attribute of a certain one of the entities 193 and 196, as indicated by correspondence arrows 199. For instance, the value of the D1 parameter may indicate the name of a certain entity (e.g., primary entity 193), the identifier assigned to the primary entity 193, the physical address of the primary entity 193, the network address of the primary entity 193, and/or contact information for the primary entity 193. The value of the D2 parameter may indicate further relevant data of the primary entity 193. In embodiments, the dataset values indicate attributes of both the primary entity 193 and the secondary entity 196, as indicated by correspondence arrows 199, but that is not required. The value of the B1 parameter may indicate the (numerical) base value for the relationship instance. The value of the PC parameter may indicate a category assigned to the relationship instance. The value of the DD parameter may indicate a textual description of an aspect of the relationship instance.

The dataset 135 may further have additional dataset parameters, as indicated by the horizontal dot-dot-dot in the right side of the dataset 135. In this document, a dot-dot-dot, whether horizontal or vertical, means “potentially more of” what it is shown together with. This is just one illustrative example of a suitable dataset 135. Other embodiments may have only some of these parameters, may have different parameters entirely, the parameters may be rearranged variously within the dataset 135, and so on.

A relationship instance 197 may be associated with a domain 181. The relationship instance 197 may be associated with the domain 181 due to the primary entity 193 associated with the relationship instance 197 being geographically located within the domain 181 or otherwise being associated with the domain 181 and/or the secondary entity 196 associated with the relationship instance being geographically located within the domain 181 or otherwise being associated with the domain 181. The domain 181 may have domain rules. The domain rules of the domain 181 may include rules for producing resources for relationship instances associated with the domain 181 and/or rules indicating how datasets should be prepared. A relationship instance 197 associated with a domain 181 may be subject to the domain rules of the domain 181.

In embodiments, the computer system 195 may identify a domain 181 associated with the relationship instance 197 represented by the dataset 135. In an embodiment, the computer system 195 identifies the domain 181 based on the primary entity 193 associated with the relationship instance 197. In an embodiment, the primary entity 193 or user 192 provides domain information to the computer system 195 separately from the dataset 135 and the computer system 195 identifies the domain 181 based on the received domain information. In an embodiment, the computer system 195 infers the domain 181 based on parameter values included in the dataset 135 and/or other information provided by the primary entity 193 or known about the primary entity 193 and/or the secondary entity 196 (e.g., a component of a mailing address of the primary entity 193 or the secondary entity 196).

In embodiments, the computer system 195 produces a resource for the dataset 135, such as the resource 179. The produced resource 179 can be a document, a determination, a computational result, etc., made, created or prepared for the user 192, the primary entity 193, and/or the secondary entity 196, etc. As such, in some embodiments, the resource 179 is produced by processing and/or a computation. In some embodiments, the resource 179 for a dataset 135 is produced based at least on the value of the B1 parameter (i.e., a base value) of the dataset 135.

The dataset 135 is shown only as an example. In fact, the computer system 195 may receive multiple datasets for multiple domains from the primary entity 193, for its relationship instances. Also, datasets may be received incrementally over a long time.

In embodiments, digital rules are provided for use by the OSP 198. The digital rules may correspond to the domain rules of a domain 181. The digital rules are digital in that they are implemented for use by software. For example, the digital rules may be implemented within the programs 131 and/or the data 138. The data portion of the digital rules may alternately be stored in memories, locally or in other places that can be accessed by the computer system 195. The storing can be in the form of a spreadsheet, a database, etc. One or more digital rules may be provided for a domain 181. Different sets of digital rules may be provided for different domains.

In embodiments, the computer system 195 may access the stored digital rules of the domain 181 that was identified. This accessing may be performed responsive to the computer system 195 receiving one or more datasets, such as the dataset 135.

Then the computer system 195 may select a certain one of the accessed digital rules. The computer system 195 may select a certain digital rule responsive to one or more of the dataset values of the dataset parameters of the dataset 135. The selected digital rule may be associated with the identified domain 181. In fact, the whole set of these digital rules may be associated with the identified domain, while other sets (not shown) may be associated with different domains.

The computer system 195 may produce the resource 179 by applying the certain digital rule, which was previously selected, responsive to at least one of the dataset values of the dataset parameters of the dataset 135. For example, the resource 179 may be produced for the dataset 135 by the computer system 195 applying a certain digital rule.

The produced resource 179 can be a document, a determination, a computational result, etc., made, created or prepared for the user 192, the primary entity 193, and/or the secondary entity 196, etc. As such, in some embodiments, the resource 179 is produced by processing and/or a computation. In some embodiments, therefore, the resource 179 is produced on the basis of a characterized attribute of the primary entity 193 and/or the secondary entity 196.

The resource 179 may be produced in a number of ways. For instance, at least one of the dataset values can be a numerical base value (e.g., the value of the B1 parameter), as mentioned above. In such cases, applying the certain digital rule may include performing a mathematical operation on the base value. For example, applying the certain digital rule may include multiplying the numerical base value with a number indicated by the certain digital rule. Examples of small such numbers include 0.015, 0.03, 0.05, and so on, but the numbers need not be small or only positive. Such a number can be indicated directly by the certain digital rule, or be stored in a place indicated by the certain digital rule, or by the dataset 135, and so on.

In some embodiments two or more digital rules may be applied to produce the resource 179. For example, the computer system 195 may select, responsive to one or more of the dataset values, another one of the accessed digital rules. These one or more dataset values can be the same as, or different than, the one or more dataset values responsive to which the first selected digital rule was selected. In such embodiments, the resource 179 can be produced by the computer system 195 also applying the other selected digital rule to at least one of the dataset values. For instance, where the base value B1 is used, applying the first selected digital rule may include multiplying the numerical base value B1 with a first number indicated by the first selected digital rule, so as to compute a first product. In addition, applying the second selected digital rule may include multiplying the numerical base value B1 with a second number indicated by the second selected digital rule, so as to compute a second product. And, a value of the resource may be produced by summing the first product and the second product.

In embodiments, a notification can be caused to be transmitted (e.g., via the communications network 188), by the computer system P2195. For example, a notification can be caused to be transmitted by the computer system 195, for example as an answer or other response to the received dataset 135.

The notification can be about an aspect of the resource 179, and possibly not about the whole resource. Or, the notification can be about the whole resource. In particular, the notification may inform about the aspect of the resource 179, namely that it has been determined, or where it can be found, or what it is, or a portion of its content, or a value of it, or a statistic of the value, or a rounded version of the value, and so on. Of course, the planning should be such that the recipient of the notification is able to parse what it is being provided, use it properly, and so on.

The notification can be transmitted to one of an output device and another device. The output device may be the screen of a local user or a remote user. The notification may thus cause a desired image, message, or other such notification to appear on the screen, such as within a Graphical User Interface (GUI) and so on. The other device can be the remote device, from which the dataset 135 was received. In particular, the computer system 195 may cause the notification to be communicated by being encoded as a payload, which is carried by a response. The response may be transmitted via the communications network 188 responsive to the received request. The response may be transmitted to the computer system 190, or to the OPF 189, and so on. As such, the other device can be the computer system 190, or the OPF 189, or the screen 191 of the user 192, and so on. A single payload may encode the entire notification, but that is not required. Similarly with what is written above about encoding datasets in payloads, the notification instead may be provided via two or more payloads, or in other cases the notification and at least one other notification may be included in the same single payload. Along with the aspect of the resource 179, it can be advantageous to embed in the payload the value of the identity parameter (ID) and/or the values of one or more other parameters of the dataset 135. This will help the recipient correlate the response to the request, and therefore match the received aspect of the resource 179 as the answer or other response to the appropriate dataset.

The computer system 190, the computer system 195, and possibly also the OPF 189 may exchange requests and responses. Such can be implemented with a number of different architectures. Two sample such architectures are now described with reference to the computer systems 190 and 195 only.

In one such architecture, a device remote to the service engine 183, such as the computer system 190, may have a certain application (not shown) and a connector (not shown) that is a plugin that sits on top of that certain application. The connector may be able to fetch from the remote device the details required for the service desired from the OSP 198, form an object or payload, and then send or push a request that carries the payload to the service engine 183 via a service call. The service engine 183 may receive the request with its payload. The service engine 183 may then access the digital rules, find the appropriate one(s) of them, and apply it or them to the payload to produce the requested resource 179. The service engine 183 may then form a payload that includes an aspect of the resource 179, and then push, send, or otherwise cause to be transmitted a response that carries the payload it formed to the connector. The connector receives the response, reads its payload, and forwards that payload to the certain application.

An alternative such architecture uses Representational State Transfer (REST) Application Programming Interfaces (APIs). REST or RESTful API design is designed to take advantage of existing protocols. While REST can be used over nearly any protocol, it usually takes advantage of Hyper Text Transfer Protocol (HTTP) when used for Web APIs. In such an alternative architecture, a device remote to the service engine 183, such as the computer system 190, may have a particular application (not shown). In addition, the computer system 195 implements a REST API (not shown). This alternative architecture enables the primary entity 193 to directly consume a REST API from their particular application, without using a connector. The particular application of the remote device may be able to fetch internally from the remote device the details required for the service desired from the OSP 198, and thus send or push the request to the REST API. In turn, the REST API talks in the background to the service engine 183. Again, the service engine 183 determines the requested resource 179, and sends an aspect of it back to the REST API. In turn, the REST API sends the response that has the payload to the particular application.

The digital rules may be implemented as simple rules. A simple rule has a single condition (“P”) and a single consequent (“Q”). As a result of an initial search, the digital rule is selected, and then its consequent is applied to produce the resource 179.

In some embodiments, the digital rules further include additional digital rules that select that digital rule in the first place, for ultimately applying it. In such embodiments, the digital rules can be implemented as simple rules or as complex rules. Complex rules may have more than one conditions and/or more than one consequents. Complex rules may be implemented as individual single rules with complex coding. Alternatively, a complex rule may be implemented in part by more than one simpler individual rules, which can have hierarchical relationships among them (e.g., from one digital rule's application or execution leading to another, and so on). As a result of the initial search, then, digital rules are found which, when applied, select that certain digital rule in the first place.

In embodiments, the computer system 195 provides a discontinuity monitoring service that monitors datasets for discontinuities with respect to certain parameters and reacts to any discontinuities that exist in those datasets (e.g., via operations of the service engine 183). For example, as will be described in additional detail herein, the discontinuity monitoring service may monitor datasets of relationship instances associated with a particular entity (e.g., primary entity 193) and a domain 181 for discontinuities with respect to monitored parameters (e.g., configured by a user 192 of the OSP) and perform a reactive action if a discontinuity exists in the datasets.

The user 192 may configure the computer system 195 with the specific parameters that the OSP 198 should monitor for discontinuities (e.g., the parameters that matter for the user 192). In embodiments, the OSP 198 charges/bills the user 192 based on how many parameters the OSP 198 monitors for discontinuities.

In embodiments, the computer system 195 has access to historical datasets 105. The historical datasets 105 may include datasets received by the computer system 195 over a period of time, including datasets of relationship instances associated with the primary entity 193 and the domain 181, as well as datasets of relationship instances associated with other primary entities and the domain 181. The historical datasets 105 may be stored locally at the computer system 195 itself, stored remotely from the computer system 195, or both. If historical datasets 105 are stored remotely, the computer system 195 may access those historical datasets via a network (e.g., network 188).

The computer system 195 may identify patterns 110 in the historical datasets 105 with respect to the monitored parameters and store those patterns 110 in memory 130. For example, the computer system 195 may accumulate statistics for a monitored parameter of the historical datasets 105 such as the mode value for the monitored parameter (the most commonly appearing value), the average value for the monitored parameter, the standard deviation for the monitored parameter, the percentage of datasets in which the monitored parameter has a particular value, a percentage of datasets in which the monitored parameter has a particular value when a description parameter has a particular description value, and a trend of values for the monitored parameter (e.g., the value increases or decreases by a certain percentage every period compared to a previous period). Multiple parameters and their relationships to each other may be evaluated when identifying a pattern. Each of the patterns 110 may be stored with a pattern ID that uniquely identifies the pattern, the parameter(s) associated with the pattern, the domain associated with the pattern, the time period associated with the pattern, and/or details regarding the pattern itself (e.g., the statistics for the parameters).

In an embodiment, the computer system 195 trains a discontinuity machine learning model using the historical datasets 105 (as training data) to learn the patterns 110. In this case, the patterns 110 may be called “tones.”

When the computer system 195 receives datasets of relationship instances associated with the primary entity 193 and the domain 181, the computer system 195 may produce a resource 179 by applying digital rules to the received datasets, and also determine whether a discontinuity exists in the received datasets based on comparing the datasets against the patterns 110. In an embodiment (where the computer system 195 has trained a discontinuity machine learning model or otherwise has access to a discontinuity machine learning model), the computer system 195 determines whether a discontinuity exists in the received datasets by applying the (previously trained) discontinuity model to the received datasets. The discontinuity model may take into account multiple parameters, their relationships to each other, and their relative importance/weights when determining whether a discontinuity exists in datasets.

Generally, a discontinuity, as used herein, is a deviation from historical norms/patterns. The threshold of what is considered to be a discontinuity (e.g., how much change, over how much time, and/or what threshold gradient has to be exceeded to be considered a discontinuity) may vary depending on the implementation and may be configurable by a user 192.

If the computer system 195 determines that a discontinuity exists in the received datasets, the computer system 195 may perform a reactive action that involves as aspect associated with the primary entity 193 or the received datasets. The reactive action may include, for example, transmitting a notification regarding the discontinuity to an agent of the entity (e.g., user 192), generating a processing error for a dataset included in the second set of datasets, logging information regarding the discontinuity for viewing by an agent of the entity, and/or modifying a dataset included in the received datasets.

In an embodiment, the computer system 195 determines one or more notification thresholds for the monitored parameters based on the patterns 110. The computer system 195 may determine whether any values of the monitored parameters of the received datasets crosses any of applicable notification thresholds, and transmit a notification (e.g., to appear in a UI screen) if a notification threshold is crossed.

The discontinuity monitoring service works by comparing current datasets against patterns identified in historical datasets. In an embodiment, the current datasets and the historical datasets were received by the computer system 195 in the past. That is, the current datasets can be previously received datasets and need not be recently received datasets. In an embodiment, the current datasets are recently received datasets and the historical datasets are datasets that were received before the current datasets were received. In an embodiment, the current datasets and the historical datasets are received at the same time. In such an embodiment, the computer system 195 may receive the datasets and separate the datasets according to time period (e.g., separate the datasets into datasets of relationship instances associated with a first time period and datasets of relationship instances associated with a second time period, where the second time period comes after the first time period). In an embodiment, the computer system 195 receives datasets of relationship instances associated with multiple domains and the computer system 195 separates the datasets according to domain. Patterns may be identified per domain. In an embodiment, the computer system 195 parses and extracts dataset values from datasets.

As an example, the computer system 195 may monitor the number of times that a certain parameter (e.g., PC) has a certain value and store that number as a pattern. If the computer system 195 receives new datasets and the number of times that the certain parameter has the certain value in the new datasets is significantly greater than the stored number or significantly less than the stored number (what is considered “significant” can be configured by the user 192 or the OSP 198), then the computer system 195 may determine that a discontinuity exists in the new datasets.

As another example, the computer system 195 may monitor the number of times that a certain parameter (e.g., PC) has a certain value, as a percentage of datasets in which a description parameter (e.g., DD) has a certain description value, where the certain value is meant to characterize the description value. The computer system 195 may store the percentage as a pattern. If the computer system 195 receives new datasets and the percentage of datasets in which the certain parameter has the certain value when the description parameter has the certain description value is significantly greater than the stored percentage or significantly less than the stored percentage, then the computer system 195 may determine that a discontinuity exists in the new datasets.

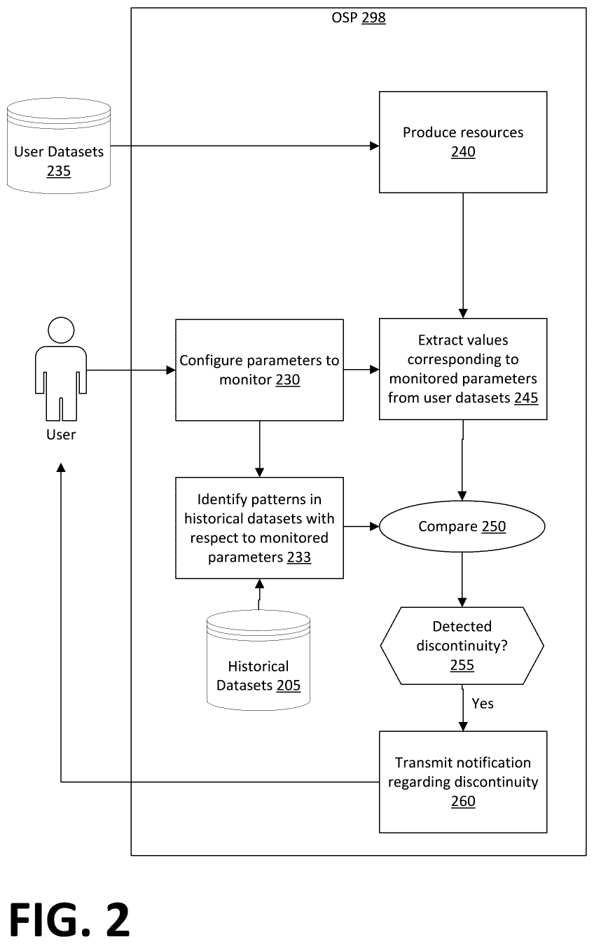

FIG. 2 is a diagram showing operations performed by an OSP for monitoring for discontinuities, according to some embodiments.

As shown in the diagram, at operation 230, a user of the OSP 298 may configure the OSP to monitor certain parameters for discontinuities (these parameters may be referred to as monitored parameters). At operation 233, The OSP 298 may identify patterns in the historical datasets 205 with respect to the monitored parameters and store the patterns. The historical datasets 205 may include datasets of relationship instances associated with a particular domain that were previously received by the OSP 298. At operation 240, the OSP 298 may receive user datasets 235 and produce resources based on the user datasets 235. The user datasets 235 may be datasets of relationship instances associated with a particular entity (e.g., an entity associated with the user of the OSP) and the particular domain. At operation 245, the OSP 298 may parse and extract values corresponding to the monitored parameters from the user datasets 235. At operation 250, the OSP 298 may compare the extracted values against the patterns identified in the historical datasets 205 (the patterns identified at operation 233) to determine whether any discontinuities exist in the user datasets 235 with respect to the monitored parameters. At decision block 255, if a discontinuity exists in the user datasets 235 with respect to the monitored parameters, the OSP 298 may perform operation 260. At operation 260, the OSP 298 may transmit a notification regarding the discontinuity to the user. The notification may include information regarding the discontinuity such as the particular dataset(s) that contributed to the discontinuity, the parameter(s) that contributed to the discontinuity, the dataset values that contributed to the discontinuity, a textual description of the discontinuity, or the like. The notification may also include information regarding the produced resource (that was produced at operation 240).

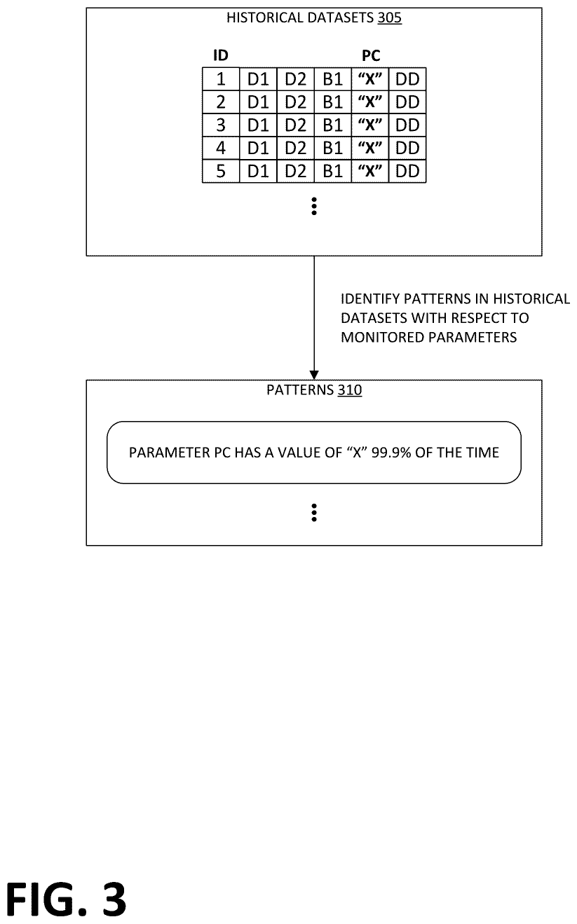

FIG. 3 is a diagram showing an example of identifying patterns in historical datasets, according to some embodiments.

As shown in the diagram, the historical datasets 305 may include multiple datasets having parameters ID, D1, D2, B1, PC, and DD. Five datasets are shown in the diagram, but there may be additional datasets as indicated by the dot-dot-dot. Each dataset may have a unique ID parameter value. For example, the first dataset has an ID parameter value of “1,” the second dataset has an ID parameter value of “2,” and so on. Also, in this example, it is assumed that 99.9% of the datasets, including the five datasets that are shown in the diagram, have a PC parameter value of “X.” The values of the other parameters are not important for understanding how patterns 310 are identified in the context of this particular example so their actual values are not shown in the diagram.

A computer system (e.g., the computer system 195) may identify patterns 310 in the historical datasets 305 with respect to monitored parameter(s) by analyzing the historical datasets 305. In this example, it is assumed that parameter PC is one of the parameters being monitored and that the computer system identifies a pattern that parameter PC has a value of “X” 99.9% of the time. The computer system may then store this pattern so that it can be used for detecting discontinuities. The computer system may identify additional patterns as indicated by the dot-dot-dot.

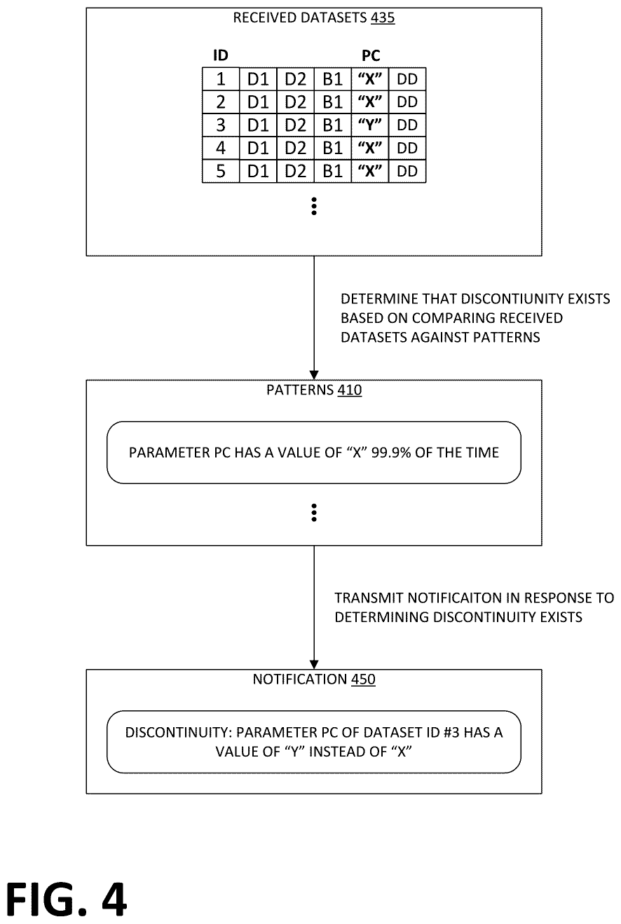

FIG. 4 is a diagram showing an example of determining that a discontinuity exists in received datasets, according to some embodiments.

As shown in the diagram, the received datasets 435 may include multiple datasets having parameters ID, D1, D2, B1, PC, and DD. Five datasets are shown in the diagram, but there may be additional datasets as indicated by the dot-dot-dot. Each dataset may have a unique ID parameter value. For example, the first dataset has an ID parameter value of “1,” the second dataset has an ID parameter value of “2,” and so on. For sake of simplicity, the received datasets 435 have the same ID parameter values as the historical datasets 305 shown in FIG. 3, but it should be appreciated that the received datasets 435 may have different ID parameter values from the ID parameter values of the historical datasets 305. Also, in this example, the dataset having an ID parameter value of “1” has a PC parameter value of “Y,” while the other datasets shown in the diagram have a PC parameter value of “X.”

A computing system (e.g., computing system 195) may determine that a discontinuity exists in the received datasets 435 based on comparing the PC parameter values of the received datasets 435 against the patterns 410 including the pattern indicating that parameter PC has a value of “X” 99.9% of the time. In this example, the computer system determines that the discontinuity exists because the value of the PC parameter of the dataset having ID parameter value of “3” has a value of “Y” instead of “X,” which deviates from the pattern that parameter PC has a value of “X” 99.9% of the time.

Responsive to determining that the discontinuity exists, the computer system may transmit a notification 450 indicating there is a discontinuity in the received datasets 435 because parameter PC of the dataset having ID parameter value of “3” has a value of “Y” instead of “X.”

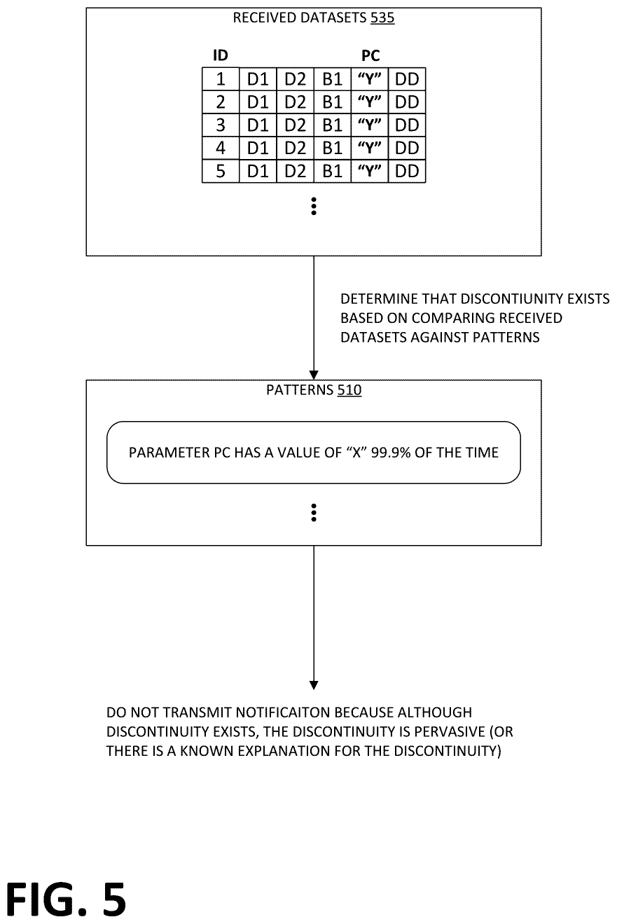

FIG. 5 is a diagram showing an example of determining that a discontinuity exists in received datasets but not transmitting a notification because the discontinuity is pervasive, according to some embodiments.

As shown in the diagram, the received datasets 535 may include multiple datasets having parameters ID, D1, D2, B1, PC, and DD. Five datasets are shown in the diagram, but there may be additional datasets as indicated by the dot-dot-dot. Each dataset may have a unique ID parameter value. For example, the first dataset has an ID parameter value of “1,” the second dataset has an ID parameter value of “2,” and so on. For sake of simplicity, the received datasets 535 have the same ID parameter values as the historical datasets 305 and the received datasets 435 shown in FIG. 3 and FIG. 4, respectively, but it should be appreciated that the received datasets 535 may have different ID parameter values from the ID parameter values of the historical datasets 305 and the received datasets 435. Also, it is assumed in this example that all of the received datasets 535 or a vast majority of the received datasets 535 have a PC parameter value of “Y.”

In an embodiment, even if a computing system (e.g., computing system 195)

determines that a discontinuity exists in the received dataset 535, the computing system does not transmit a notification regarding the discontinuity if the discontinuity is pervasive (e.g. it affects many datasets)—what is considered to be “pervasive” may vary depending on the particular implementation. A discontinuity being pervasive may indicate that the discontinuity is a result of an intentional change/action, and thus does not warrant notification.

For example, the computing system may determine that a discontinuity exists in the received datasets 535 based on comparing the PC parameter values of the received datasets 535 against the patterns 510 including the pattern indicating that parameter PC has a value of “X” 99.9% of the time. However, the computer system does not transmit a notification regarding the discontinuity in this case because, although a discontinuity exists, the discontinuity is pervasive (there are many datasets having a PC parameter value of “Y” instead of “X”) or there is some other explanation for the discontinuity (e.g., the values of other parameters of the datasets suggest that “Y” is the appropriate value for the PC parameter or the digital rules indicate that “Y” is the appropriate value for the PC parameter).

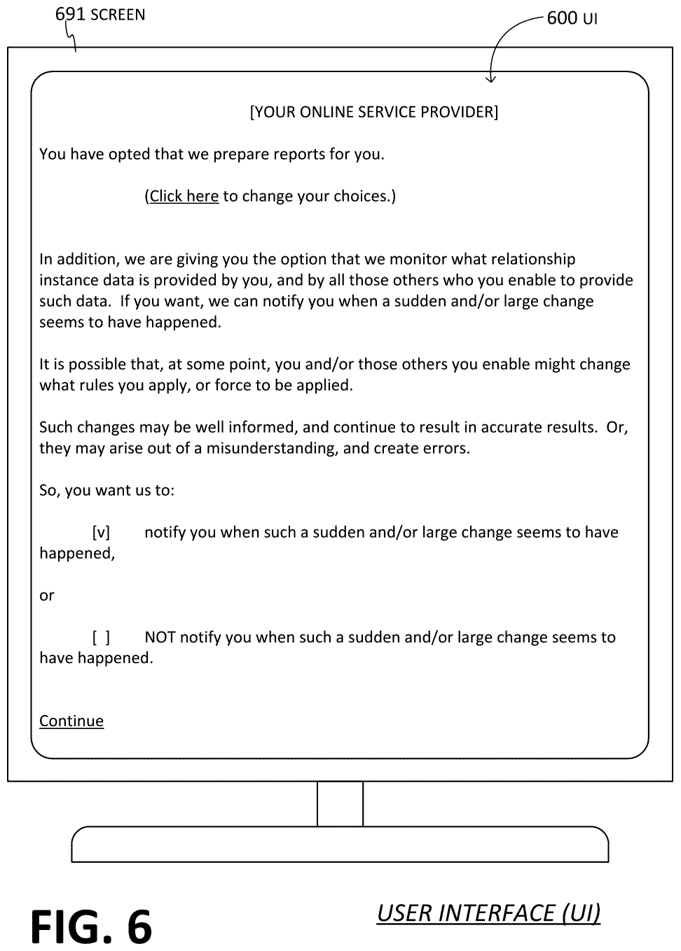

FIG. 6 is a diagram showing a sample UI shown on a screen, according to some embodiments. The screen 691 could be the screen 191 of FIG. 1. The UI 600 may be displayed on the screen 691 to allow a user to choose to be notified when a sudden/large change occurs (i.e., a discontinuity exists) in datasets of relationship instances associated with an entity. In particular, the UI 600 presents an option for the user to choose to be notified or not notified when a sudden/large change occurs in datasets.

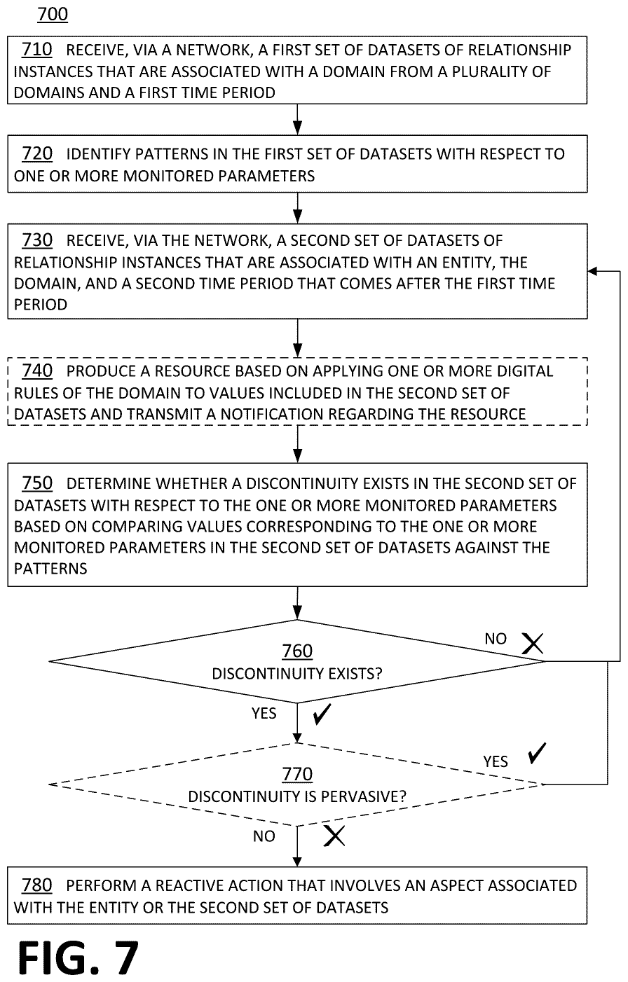

FIG. 7 is a flowchart for a method to monitor for discontinuities in datasets, according to some embodiments. The method 700 may be performed by a computer system, such as the sample computer system 195 of FIG. 1, the computer system 890 or 895 of FIG. 8, or another suitable computer system. The computer system performing the method 700 may be part of an OSP.

At operation 710, the computer system receives, via a network, a first set of datasets of relationship instances that are associated with a domain from a plurality of domains and a first time period. In an embodiment, the first set of datasets includes datasets of relationship instances associated with a particular entity (e.g., the entity associated with the relationship instances represented by the second set of datasets mentioned in operation 730). In an embodiment, the first set of datasets further includes datasets of relationship instances associated with entities other than the particular entity.

At operation 720, the computer system identifies patterns in the first set of datasets with respect to one or more monitored parameters. In an embodiment, the one or more monitored parameters are configurable by a user of the OSP. In an embodiment, the patterns include statistics for a monitored parameter from the one or more monitored parameters. In an embodiment, the statistics for the monitored parameter include one or more of: a mode value for the monitored parameter, an average value for the monitored parameter, a standard deviation for the monitored parameter, a percentage of datasets in which the monitored parameter has a particular value, a percentage of datasets in which the monitored parameter has a particular value when a description parameter has a particular description value, and a trend of values for the monitored parameter. In an embodiment, the identifying the patterns in the first set of datasets comprises training a discontinuity machine learning model using the first set of datasets to learn the patterns, wherein the determining whether the discontinuity exists in the second set of datasets comprises applying the discontinuity model to the second set of datasets.

At operation 730, the computer system receives, via the network, a second set of datasets of relationship instances that are associated with an entity, the domain, and a second time period that comes after the first time period.

In an embodiment, the OSP maintains digital rules of the domain that correspond to domain rules of the domain.

In an embodiment, at operation 740, the computer system produces a resource based on applying one or more digital rules of the domain to values included in the second set of datasets and transmits a notification regarding the resource (e.g., to an agent of the entity).

At operation 750, the computer system determines whether a discontinuity exists in the second set of datasets with respect to the one or more monitored parameters based on comparing values corresponding to the one or more monitored parameters in the second set of datasets against the patterns.

At decision block 760, if a discontinuity does not exist in the second set of datasets with respect to the one or more parameters, the method proceeds back to operation 730 to receive additional datasets of relationship instances associated with the entity and the domain. Otherwise, if a discontinuity exists in the second set of datasets with respect to the one or more parameters, the method proceeds to operation 770 (optional) or operation 780.

In an embodiment, the computer system determines whether the discontinuity is pervasive. At decision block 770, if the discontinuity is pervasive, the method proceeds back to operation 730 to receive additional datasets of relationship instances associated with the entity and the domain (e.g., without performing a reactive action). Otherwise, if the discontinuity is not pervasive, then the method proceeds to operation 780.

At operation 780, the computer system performs a reactive action that involves an aspect associated with the entity or the second set of datasets. In an embodiment, the reactive action is configurable by a user of the OSP. In an embodiment, the reactive action includes one or more of: transmitting a notification regarding the discontinuity to an agent of the entity, generating a processing error for a dataset included in the second set of datasets, logging information regarding the discontinuity for viewing by an agent of the entity, and modifying a dataset included in the second set of datasets. In an embodiment, the reactive action includes determining whether the domain rules of the domain have changed and responsive to determining that the domain rules of the domain have changed, updating the digital rules of the domain maintained by the OSP.

In an embodiment, the computer system generates a UI that allows a user of the OSP to request that the OSP monitor for discontinuities in datasets of relationship instances associated with the entity and causes the user interface to be displayed on a screen of a device operated by the user.

### Details about Computer Systems

FIG. 8 is a diagram showing details of a sample computer systems, according to some embodiments. The computer system 895 may be a server, while the computer system 890 may be a personal device, such as a personal computer, a desktop computer, a personal computing device such as a laptop computer, a tablet computer, a mobile phone, and so on. Either type may be used for the computer system 195 and 190 of FIG. 1, and/or a computer system that is part of OPF 189.

The computer system 895 and the computer system 890 have similarities, which FIG. 8 exploits for purposes of economy in this document. It will be understood, however, that a component in the computer system 895 may be implemented differently than the same component in the computer system 890. For instance, a memory in a server may be larger than a memory in a personal computer, and so on. Similarly, custom application programs 874 that implement embodiments may be different, and so on.

The computer system 895 includes one or more processors 894. The processor(s) 894 are one or more physical circuits that manipulate physical quantities representing data values. The manipulation can be according to control signals, which can be known as commands, op codes, machine code, etc. The manipulation can produce corresponding output signals that are applied to operate a machine. As such, one or more processors 894 may, for example, include a Central Processing Unit (CPU), a Reduced Instruction Set Computing (RISC) processor, a Complex Instruction Set Computing (CISC) processor, a Graphics Processing Unit (GPU), a Digital Signal Processor (DSP), a Field-Programmable Gate Array (FPGA), an Application Specific Integrated Circuit (ASIC), any combination of these, and so on. A processor may further be a multi-core processor having two or more independent processors that execute instructions. Such independent processors are sometimes called “cores”.

A hardware component such as a processor may also include programmable logic or circuitry that is temporarily configured by software to perform certain operations. For example, a hardware component may include software executed by a general-purpose processor or another type of programmable processor. Once configured by such software, hardware components become specific machines, or specific components of a machine, uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost, time, and performance considerations.

As used herein, a “component” may refer to a device, physical entity or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. The hardware components depicted in the computer system 895, or the computer system 890, are not intended to be exhaustive. Rather, they are representative, for highlighting essential components that can be used with embodiments.

The computer system 895 also includes a system bus 812 that is coupled to the processor(s) 894. The system bus 812 can be used by the processor(s) 894 to control and/or communicate with other components of the computer system 895.

The computer system 895 additionally includes a network interface 819 that is coupled to system bus 812. Network interface 819 can be used to access a communications network, such as the network 188. Network interface 819 can be implemented by a hardware network interface, such as a Network Interface Card (NIC), wireless communication components, cellular communication components, Near Field Communication (NFC) components, Bluetooth® components such as Bluetooth® Low Energy, Wi-Fi® components, etc. Of course, such a hardware network interface may have its own software, and so on.

The computer system 895 also includes various memory components. These memory components include memory components shown separately in the computer system 895, plus cache memory within the processor(s) 894. Accordingly, these memory components are examples of non-transitory machine-readable media. The memory components shown separately in the computer system 895 are variously coupled, directly or indirectly, with the processor(s) 894. The coupling in this example is via the system bus 812.

Instructions for performing any of the methods or functions described in this document may be stored, completely or partially, within the memory components of the computer system 895, etc. Therefore, one or more of these non-transitory computer-readable media can be configured to store instructions which, when executed by one or more processors 894 of a host computer system such as the computer system 895 or the computer system 890, can cause the host computer system to perform operations according to embodiments. The instructions may be implemented by computer program code for carrying out operations for aspects of this document. The computer program code may be written in any combination of one or more programming languages, including an object-oriented programming language such as Java, Smalltalk or the like, and/or conventional procedural programming languages, such as the “C” programming language or similar programming languages such as C++, C Sharp, etc.

The memory components of the computer system 895 include a non-volatile hard drive 833. The computer system 895 further includes a hard drive interface 832 that is coupled to the hard drive 833 and to the system bus 812.

The memory components of the computer system 895 include a system memory 838. The system memory 838 includes volatile memory including, but not limited to, cache memory, registers and buffers. In embodiments, data from the hard drive 833 populates registers of the volatile memory of the system memory 838.

In some embodiments, the system memory 838 has a software architecture that uses a stack of layers, with each layer providing a particular functionality. In this example the layers include, starting from the bottom, an Operating System (OS) 850, libraries 860, frameworks/middleware 868 and application programs 870, which are also known as applications 870. Other software architectures may include less, more, or different layers. For example, a presentation layer may also be included. For another example, some mobile or special purpose operating systems may not provide a frameworks/middleware 868.

The OS 850 may manage hardware resources and provide common services. The libraries 860 provide a common infrastructure that is used by the applications 870 and/or other components and/or layers. The libraries 860 provide functionality that allows other software components to perform tasks more easily than if they interfaced directly with the specific underlying functionality of the OS 850. The libraries 860 may include system libraries 861, such as a C standard library. The system libraries 861 may provide functions such as memory allocation functions, string manipulation functions, mathematical functions, and the like.

In addition, the libraries 860 may include API libraries 862 and other libraries 863. The API libraries 862 may include media libraries, such as libraries to support presentation and manipulation of various media formats such as MPREG4, H.264, MP3, AAC, AMR, JPG, and PNG. The API libraries 862 may also include graphics libraries, for instance an OpenGL framework that may be used to render 2D and 3D in a graphic content on the screen 891. The API libraries 862 may further include database libraries, for instance SQLite, which may support various relational database functions. The API libraries 862 may additionally include web libraries, for instance WebKit, which may support web browsing functionality, and also libraries for applications 870.

The frameworks/middleware 868 may provide a higher-level common infrastructure that may be used by the applications 870 and/or other software components/modules. For example, the frameworks/middleware 868 may provide various Graphic User Interface (GUI) functions, high-level resource management, high-level location services, and so forth. The frameworks/middleware 868 may provide a broad spectrum of other APIs that may be used by the applications 870 and/or other software components/modules, some of which may be specific to the OS 850 or to a platform.

The application programs 870 are also known more simply as applications and apps. One such app is a browser 871, which is a software that can permit the user 192 to access other devices in the internet, for example while using a Graphic User Interface (GUI). The browser 871 includes program modules and instructions that enable the computer system 895 to exchange network messages with a network, for example using Hypertext Transfer Protocol (HTTP) messaging.

The application programs 870 may include one or more custom applications 874, made according to embodiments. These can be made so as to cause their host computer to perform operations according to embodiments. Of course, when implemented by software, operations according to embodiments may be implemented much faster than may be implemented by a human mind; for example, tens or hundreds of such operations may be performed per second according to embodiments, which is much faster than a human mind can do.

Other such applications 870 may include a contacts application, a book reader application, a location application, a media application, a messaging application, and so on. Applications 870 may be developed using the ANDROID™ or IOS™ Software Development Kit (SDK) by an entity other than the vendor of the particular platform, and may be mobile software running on a mobile operating system such as IOS™, ANDROID™, WINDOWS® Phone, or other mobile operating systems. The applications 870 may use built-in functions of the OS 850, of the libraries 860, and of the frameworks/middleware 868 to create user interfaces for the user 192 to interact with.

The computer system 895 moreover includes a bus bridge 820 coupled to the system bus 812. The computer system 895 furthermore includes an input/output (I/O) bus 821 coupled to the bus bridge 820. The computer system 895 also includes an I/O interface 822 coupled to the I/O bus 821.

For being accessed, the computer system 895 also includes one or more Universal Serial Bus (USB) ports 829. These can be coupled to the I/O interface 822. The computer system 895 further includes a media tray 826, which may include storage devices such as CD-ROM drives, multi-media interfaces, and so on.

The computer system 890 may include many components similar to those of the computer system 895, as seen in FIG. 8. In addition, a number of the application programs may be more suitable for the computer system 890 than for the computer system 895.

The computer system 890 further includes peripheral input/output (I/O) devices for being accessed by a user more routinely. As such, the computer system 890 includes a screen 891 and a video adapter 828 to drive and/or support the screen 891. The video adapter 828 is coupled to the system bus 812.

The computer system 890 also includes a keyboard 823, a mouse 824, and a printer 825. In this example, the keyboard 823, the mouse 824, and the printer 825 are directly coupled to the I/O interface 822. Sometimes this coupling is via the USB ports 829.

In this context, “machine-readable medium” refers to a component, device or other tangible media able to store instructions and data temporarily or permanently and may include, but is not be limited to, a portable computer diskette, a thumb drive, a hard disk, random-access memory (RAM), read-only memory (ROM), buffer memory, flash memory, optical media, magnetic media, cache memory, an Erasable Programmable Read-Only Memory (EPROM), an optical fiber, a portable compact disc read-only memory (CD-ROM), an optical storage device, a magnetic storage device, or any suitable combination of the foregoing. The machine that would read such a medium includes one or more processors 894.

The term “machine-readable medium” should be taken to include a single medium or multiple media (e.g., a centralized or distributed database, or associated caches and servers) able to store instructions that a machine such as a processor can store, erase, or read. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methods described herein. Accordingly, instructions transform a general, non-programmed machine into a particular machine programmed to carry out the described and illustrated functions in the manner described.

A computer readable signal traveling from, to, and via these components may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

### Operational Examples—Use Cases

The above-mentioned embodiments have one or more uses. Aspects presented below may be implemented as was described above for similar aspects. Some, but not all of these aspects even have reference numerals that are similar to aspects described above, for ease of explanation and understanding.

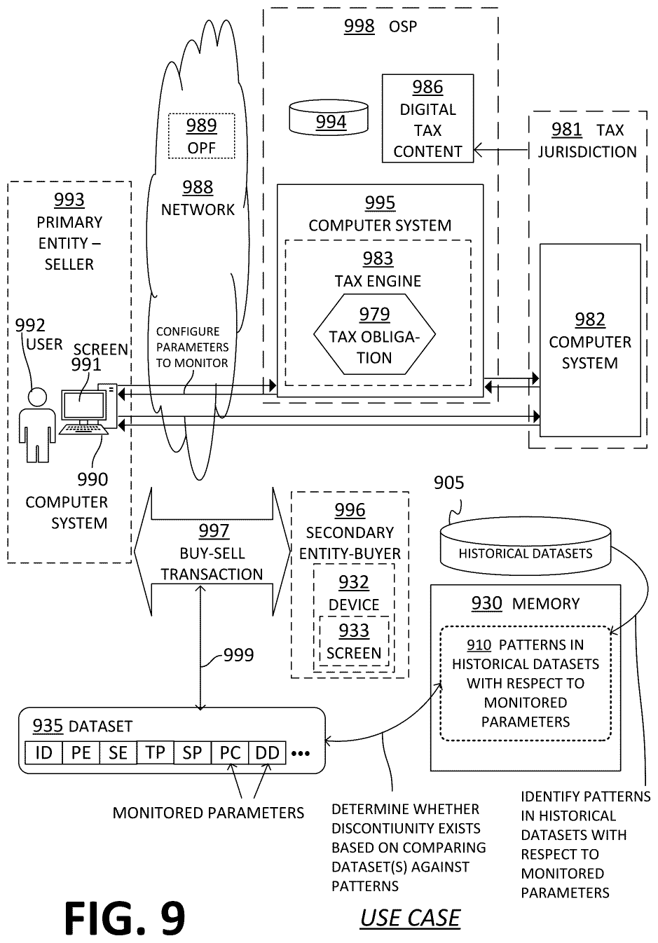

FIG. 9 is a diagram showing an operational example where a buy-sell transaction 997 is a use case of the relationship instance 197. The transaction 997 is conducted between a primary entity 993, which is a seller, and a secondary entity 996, which is a buyer. The transaction 997 is therefore a buy-sell transaction between them, for instance for a physical item, but it could be a non-physical item such as a digital item, a specific right, and so on. A tax obligation 979 often arises from the transaction 997-in particular a sales and/or use tax must be paid by either the seller 993 or the buyer 996, and/or documents must be prepared and filed, such as tax returns, compliance forms, etc. A computation of the tax obligation 979 is a use case of producing the resource 179.

It will be recognized that aspects of FIG. 9 have similarities with aspects of FIG. 1. Portions of such aspects may be implemented as described for analogous aspects of FIG. 1. In particular, a computer system 995 is shown, which is used to help customers, such as a user 992, with tax compliance. For instance, the user 992 may log into the computer system 995 by using credentials, such as a user name, a password, a token, and so on. Further in this example, the computer system 995 is part of an OSP 998 that is implemented as a Software as a Service (SaaS) provider, for being accessed by the user 992 online. As such, the OSP 998 can be an online service provider for clients. Alternately, the functionality of the computer system 995 may be provided locally to a user.

The user 992 may be standalone. The user 992 may use a computer system 990 that has a screen 991. In embodiments, the user 992 and the computer system 990 are considered part of the primary entity 993, which is also known as entity 993. The entity 993 can be a business, such as a seller of items, a reseller, a buyer, a service business, and so on. In such instances, the user 992 can be an employee, a contractor, or otherwise an agent of the entity 993.

The entity 996 can be an organization, an institution, a person, and so on. The entity 996 has a device 932 with a screen 933. The entity 996 may have used a device such as the device 932 for the buy-sell transaction 997.

The buy-sell transaction 997 may involve an operation, such as an exchange of data to form an agreement. This operation can be performed in person, or over a network 988, which can be as described elsewhere for communications networks, etc. In such cases, the entity 993 can even be an online seller, but that is not necessary. The transaction 997 will have data that is known to the entity 993, similarly with what was described by the relationship instance 197 of FIG. 1.

In a number of instances, the user 992 and/or the entity 993 use software applications to manage their business activities, such as sales, resource management, production, inventory management, delivery, billing, and so on. The user 992 and/or the entity 993 may further use accounting applications to manage purchase orders, sales invoices, refunds, payroll, accounts payable, accounts receivable, and so on. Such software applications, and more, may be used locally by the user 992, or from an OPF 989 that has been engaged for this purpose by the user 992 and/or the entity 993. The OPF 989 can be analogous to the OPF 189. In such use cases, the OPF 989 can be a Mobile Payments system, a Point Of Sale (POS) system, an Accounting application, an Enterprise Resource Planning (ERP) provider, an e-commerce provider, an electronic marketplace, a Customer Relationship Management (CRM) system, and so on.

Businesses have tax obligations to various tax authorities of respective tax jurisdictions. It is often challenging to even determine what taxes are owed and to whom, because the underlying statutes and tax rules and guidance issued by the tax authorities are very complex. There are various types of tax, such as sales tax, use tax, excise tax, value-added tax, and issues about cross-border taxation including customs and duties, and many more. Some types of tax are industry specific. Each type of tax has its own set of rules. Additionally, statutes, tax rules, and rates change often, and new tax rules are continuously added. Compliance becomes further complicated when a taxing authority offers a temporary tax holiday, during which certain taxes are waived.

Tax jurisdictions are defined mainly by geography. Businesses have tax obligations to various tax authorities within the respective tax jurisdictions. There are various tax authorities, such as that of a group of countries, of a single country, of a state, of a county, of a municipality, of a city, of a local district such as a local transit district and so on. So, for example, when a business sells items in transactions that can be taxed by a tax authority, the business may have the tax obligations to the tax authority. These obligations include requiring the business to: a) register itself with the tax authority's taxing agency, b) set up internal processes for collecting sales tax in accordance with the sales tax rules of the tax authority, c) maintain records of the sales transactions and of the collected sales tax in the event of a subsequent audit by the taxing agency, d) periodically prepare a form (“tax return”) that includes an accurate determination of the amount of the money owed to the tax authority as sales tax based on the sales transactions, e) file the tax return with the tax authority by a deadline determined by the tax authority, and f) pay (“remit”) that amount of money to the tax authority. In such cases, the filing and payment frequency and deadlines are determined by the tax authority.

A challenge for businesses is that the above-mentioned software applications generally cannot provide tax information that is accurate enough for the businesses to be tax compliant with all the relevant tax authorities. The lack of accuracy may manifest itself as errors in the amounts determined to be owed as taxes to the various tax authorities, and it is plain not good to have such errors. For example, businesses that sell products and services have risks whether they over-estimate or under-estimate the sales tax due from a sale transaction. On the one hand, if a seller over-estimates the sales tax due, then the seller collects more sales tax from the buyers than was due. Of course, the seller may not keep this surplus sales tax, but instead must pay it to the tax authorities—if the seller cannot refund it to the buyers. If a buyer later learns that they paid unnecessarily more sales tax than was due, the seller risks at least harm to their reputation. Sometimes the buyer will have the option to ask the state for a refund of the excess tax by sending an explanation and the receipt, but that is often not done as it is too cumbersome for the amounts of money involved. On the other hand, if a seller under-estimates the sales tax due, then the seller collects less sales tax from the buyers, and therefore pays less sales tax to the authorities than was actually due. That is an underpayment of sales tax that will likely be discovered later, if the tax authority audits the seller. Then the seller will be required to pay the difference, plus fines and/or late fees, because ignorance of the law is not an excuse. Further, one should note that sales taxes can be considered trust-fund taxes, meaning that the management of a company may be held personally liable for the unpaid sales tax.

For sales in particular, making correct determinations for sales and use tax is even more complex, and therefore difficult. There are a number of factors that contribute to the complexity.

First, some state and local tax authorities have origin-based tax rules, while others have destination-based tax rules. Accordingly, a sales tax may be charged from the seller's location, meaning according to the rules of the tax authority of the seller, or from the buyer's location, meaning according to the rules of the tax authority of the buyer.

Second, the various tax authorities assess different, i.e., non-uniform, percentage rates of the sales price as sales tax, for the purchase and sale of items that involve their various tax jurisdictions. These tax jurisdictions include various states, counties, cities, municipalities, special taxing jurisdictions, and so on. As the United States switched, largely but not completely, from primarily origin-based sales tax to destination-based tax, the number of tax jurisdictions rapidly multiplied, and the incentives for local governments to implement new and varied tax rules and ever smaller jurisdictions multiplied. As such, there are over 10,000 different tax jurisdictions in the US, with many partially overlapping. Their sizes vary from as large as many square miles to as small as a single building. In parallel, tens of thousands of tax rules and tax rates have been developed.

Third, in some instances no sales tax is due at all because of the type of item sold. For example, in the year 2018 selling cowboy boots was exempt from sales tax in Texas, but not in New York. This non-uniformity gives rise to numerous individual taxability rules related to various products and services across different tax jurisdictions.

Fourth, in some instances no sales tax is due at all because of who the individual buyer is, and/or what the purchase is for. For example, certain entities are exempt from paying sales tax on their purchases, as long as they properly create and sign an exemption certificate and give it to the seller for each purchase made. Entities that are entitled to such exemptions may include wholesalers, resellers, non-profit charities, educational institutions, etc. Of course, who can be exempt is not exactly the same in each tax jurisdiction. And, even when an entity is entitled to be exempt, different tax jurisdictions may have different requirements for the certificate of exemption to be issued and/or remain valid. And, certificates of exemption may expire after some time, and may need to be renewed or reissued.

Fifth, it can be hard to determine which tax authorities a seller owes sales tax to. A seller may start with tax jurisdictions that it has a physical presence in, such as a main office, a distribution center or warehouse, an employee working remotely, and so on. Such ties with a tax jurisdiction establish the so-called physical nexus. However, a tax authority such as a state or even a city may set its own nexus rules for when a business is considered to be “engaged in business” with it, and therefore that business is subject to registration and collection of sales taxes. These nexus rules may include different types of nexus, such as affiliate nexus, click-through nexus, cookie nexus, economic nexus with thresholds, and so on. For instance, due to economic nexus, a remote seller may owe sales tax for sales made in the jurisdiction that are a) above a set threshold volume, and/or b) above a set threshold number of sales transactions.

The economic nexus mentioned above can be even more complicated. Even where a seller might not have reached any of the thresholds for economic nexus, a number of states are promulgating marketplace facilitator laws that sometimes use such thresholds. According to such laws, intermediaries that are characterized as marketplace facilitators per laws of the state may have an obligation, instead of the seller, to collect sales tax on behalf of their sellers, and remit it to the state. The situation becomes even more complex when a seller sells directly to a state, and also via such an intermediary.

To help with such complex determinations, the computer system 995 may be specialized for tax compliance. For instance, the computer system 995 thus implements a tax engine 983 to make the determinations of tax obligations. The tax engine 983 can be as described for the service engine 183.

The computer system 995 may further store locally entity data, i.e. data of user 992 and/or of entity 993, either of which/whom may be a customer, and/or a seller or a buyer in a sales transaction. The entity data may include profile data of the customer, and transaction data from which a determination of a tax obligation is desired. In the online implementation of FIG. 9, the OSP 998 has a database 994 for storing the entity data. This entity data may be inputted by the user 992, and/or caused to be downloaded or uploaded by the user 992 from the computer system 990 or from the OPF 989, or extracted from the computer system 990 or from the OPF 989, and so on. In other implementations, a simpler memory configuration may suffice for storing the entity data.

A digital tax content 986 is further implemented within the OSP 998. The digital tax content 986 can be a utility that stores digital (tax) rules for use by the tax engine 983. As part of managing the digital tax content 986, there may be continuous updates of the digital rules, by inputs gleaned from a set of different tax jurisdictions. Updating may be performed by humans, or by computers, and so on. The number of the different tax jurisdictions may be very large. In such use cases, tax jurisdictions such as a country, a state, a county, a city, a municipality, etc. correspond to domains discussed earlier in this document.

The digital rules are digital in that they are implemented for use by software. The digital rules can be created so as to accommodate legal tax rules that the set of different tax authorities promulgate to apply within the boundaries of their tax jurisdictions.

For a specific determination of a tax obligation, the computer system 995 may receive one or more datasets. A sample received dataset 935 is shown in the diagram. The dataset 935 has parameters that can also be called dataset parameters, some of which can have respective dataset values, and can be otherwise examples of what was described for the dataset 135 of FIG. 1. The computer system 990 may transmit a request that includes the dataset 935 as a payload to the computer system 995, and the computer system 995 may extract the dataset 935 by parsing the received payload. The entire dataset 935 may be encoded as a single payload or spread across multiple payloads.

In this example, the dataset 935 has been received because it is desired to determine any tax obligations arising from the buy-sell transaction 997. As such, the sample received dataset 935 has dataset parameters with values that indicate aspects of the buy-sell transaction 997, as indicated by a correspondence arrow 999. The dataset 935 may thus represent the buy-sell transaction 997. In this example the sample received dataset 935 has an ID parameter, with a value indicating an identifier of the dataset 935 and/or the transaction 997. The dataset 935 also has a parameter PE with a value for the name of the primary entity 993 or the user 992, which can be the seller making sales transactions, some perhaps online. The dataset 935 also has a parameter SE with a value for the name of the secondary entity 996, which can be the buyer. The dataset 935 also has a parameter TP with a value for the data/time at which the buy-sell transaction 997 occurred. The time period associated with the buy-sell transaction 997 can be inferred from the value of the TP parameter. Although not shown in the diagram, the dataset 935 may also have a TJ parameter, with a value indicating the relevant tax jurisdiction for tax remittance purposes (e.g., the state in which the buyer 996 resides). The tax jurisdiction may be akin to a domain 181 in certain use cases. The dataset 935 has a SP parameter, with a numerical value indicating the sale price of the item or service sold. The sales price may be akin to a base value in certain use cases. The dataset 935 has a PC parameter, with a value indicating a tax code assigned to the item sold. The tax code assigned to the item may affect the taxability of the item. The dataset 935 has a DD parameter, with a value indicating a textual description of the item/service involved in the buy-sell transaction 997.

The dataset 935 may further have additional dataset parameters, as indicated by the dot-dot-dot in the right side of the dataset 935. These parameters may indicate further aspects of the buy-sell transaction 997, such as what item was sold, for example by a Stock Keeping Unit (SKU), how many units of the item were sold in the transaction 997, and so on.

Then the computer system 995 may produce the tax obligation 979, which is akin to producing the resource 179 of FIG. 1. The tax obligation 979 is due to the tax authority of the tax jurisdiction 981. In some instances, the tax obligation 979 is fulfilled by the user 992 using the computer system 990 to access the computer system 982. In some instances, the tax obligation 979 is fulfilled by the computer system 995 accessing the computer system 982 on behalf of the user 992.

The tax jurisdiction 981 may have tax rules. The tax rules of a tax jurisdiction 981 may include rules for producing tax obligations for transactions associated with the tax jurisdiction 981 and/or rules indicating how datasets should be prepared. The computer system 995 may maintain digital (tax) rules of the domain that correspond to the tax rules of the domain (e.g., in database 994). The computer system 995 may produce the tax obligation 979 by applying one or more digital rules of the tax jurisdiction to one or more values of a dataset.

A digital rule may specify that a sales tax is due, that the amount is to be determined by a multiplication of the sale price of the value of the parameter SP by a specific rate, the tax return form that needs to be prepared and filed, a date by which it needs to be filed, and so on.

The computer system 995 may then cause a notification to be transmitted. The notification may be caused to be transmitted by the computer system 995 as an answer to the received dataset 935. The notification can be about an aspect of the tax obligation 979. For instance, the notification may inform that the tax obligation 979 has been determined, where it can be found, what it is, or at least a portion or a statistic of its content, and so on.

The notification can be transmitted to one of an output device and another device that can be the remote device, from which the dataset 935 was received. The output device may be the screen of a local user or a remote user. The notification may thus cause a desired image to appear on the screen, such as within a GUI and so on. The other device may be a remote device, as in this example. In particular, the computer system 995 causes the notification to be communicated by being encoded as a payload, which is carried by a response. The response may be transmitted via a communications network 988 responsive to the received request. The communications network 988 can be as described for the communications network 188, even the same network. The response may be transmitted to the computer system 990, or to the OPF 989, and so on. As such, the other device can be the computer system 990, or a device of the OPF 989, or the screen 991 of the user 992, and so on. A single payload may encode the entire notification, but that is not required. Of course, along with the aspect of the tax obligation 979, it is advantageous to embed in the payload the ID parameter and/or one or additional more parameters of the dataset 935. This will help the recipient correlate the response that they receive to their request, and therefore match the received aspect of the tax obligation 979 as the answer to the transmitted dataset 935.

The digital rules can be implemented or organized in different ways. For example, these digital rules may have applicability conditions that relate to geographical boundaries, effective dates with possible temporary exceptions, item classification into categories, differently-treated parties, and so on, for determining where and when a certain digital rule is to be selected and applied, to determine the tax obligation 979. These conditions may be expressed as logical conditions with ranges, dates, other data, and so on. Values of the dataset parameters of the dataset 935 can be iteratively tested against these logical conditions. In such cases, the applicable tax rules may indicate how to compute one or more tax obligations, such as to indicate different types of taxes that are due, rules, rates, exemption requirements, reporting requirements, remittance requirements, the actual amounts of tax obligations, etc.

Digital (tax) rules may be complex. For example, as described above, while a certain one of these digital resource rules is eventually selected and applied to determine the tax obligation, more than one of them may be used for selecting that certain one.

The dataset 935 is shown only as an example. In fact, the OSP 998 may receive multiple datasets for multiple tax jurisdictions from the primary entity 993, for its sales. Datasets may be received incrementally over a long time.

In embodiments, the computer system 995 provides a discontinuity monitoring service that monitors datasets for discontinuities with respect to certain parameters and reacts to any discontinuities that exits in those datasets (e.g., via operations of the tax engine 983). For example, as will be described in additional detail herein, the discontinuity monitoring service may monitor datasets of transactions associated with a particular seller 993 and a tax jurisdiction 981 for discontinuities with respect to monitored parameters (e.g., configured by a user 992 of the OSP) and perform a reactive action if a discontinuity exists in the datasets.

The user 992 may configure the computer system 995 with the specific parameters that the OSP 998 should monitor for discontinuities (e.g., the parameters that matter for the user 192). In embodiments, the OSP 998 charges/bills the user 992 based on how many parameters the OSP 998 monitors for discontinuities.

In embodiments, the computer system 995 has access to historical datasets 905. The historical datasets 905 may include datasets received by the computer system 995 over a period of time, including datasets of transactions associated with the seller 993 and the tax jurisdiction 981, as well as datasets of transactions associated with other sellers and the tax jurisdiction 981. The historical datasets 905 may be stored locally at the computer system 995 itself, stored remotely from the computer system 995, or both. If historical datasets 905 are stored remotely, the computer system 995 may access those historical datasets via a network (e.g., network 988).

The computer system 995 may identify patterns 910 in the historical datasets 905 with respect to the monitored parameters and store those patterns 910 in memory 930. For example, the computer system 995 may accumulate statistics for a monitored parameter of the historical datasets 905 such as the mode value for the monitored parameter (the most commonly appearing value), the average value for the monitored parameter, the standard deviation for the monitored parameter, the percentage of datasets in which the monitored parameter has a particular value, a percentage of datasets in which the monitored parameter has a particular value when a description parameter has a particular description value, and/or a trend of values for the monitored parameter (e.g., the value increases or decreases by a certain percentage every period compared to a previous period). Multiple parameters and their relationships to each other may be evaluated when identifying a pattern. Each of the patterns 910 may be stored with a pattern ID that uniquely identifies the pattern, the parameter(s) associated with the pattern, the tax jurisdiction associated with the pattern, the time period associated with the pattern, and/or details regarding the pattern itself (e.g., the statistics for the parameters).

In an embodiment, the computer system 995 trains a discontinuity machine learning model using the historical datasets 905 (as training data) to learn the patterns 910. In this case, the patterns 910 may be called “tones.”

When the computer system 995 receives datasets of transactions associated with the seller 993 and the tax jurisdiction 981, the computer system 995 may produce a tax obligation 979 by applying digital rules to the received datasets, and also determine whether a discontinuity exists in the received datasets based on comparing the datasets against the patterns 910. In an embodiment (where the computer system 995 has trained a discontinuity machine learning model or otherwise has access to a discontinuity machine learning model), the computer system 995 determines whether a discontinuity exists in the received datasets by applying the (previously trained) discontinuity model to the received datasets. The discontinuity model may take into account multiple parameters, their relationships to each other, and their relative importance/weights when determining whether a discontinuity exists in datasets.

The threshold of what is considered to be a discontinuity (e.g., how much change, over how much time, and/or what threshold gradient has to be exceeded to be considered a discontinuity) may vary depending on the implementation and may be configurable by a user 992.

If the computer system 995 determines that a discontinuity exists in the received datasets, the computer system 995 may perform a reactive action that involves an aspect associated with the seller 993 or the received datasets. The reactive action may include, for example, transmitting a notification regarding the discontinuity to an agent of the seller 993 (e.g., user 992), generating a processing error for a dataset included in the second set of datasets, logging information regarding the discontinuity for viewing by an agent of the seller 993, and modifying a dataset included in the received datasets.

In an embodiment, the computer system 995 determines one or more notification thresholds for the monitored parameters based on the patterns 910. The computer system 995 may determine whether any values of the monitored parameters of the received datasets crosses any of applicable notification thresholds, and transmit a notification (e.g., to appear in a UI screen) if a notification threshold is crossed.

The discontinuity monitoring service works by comparing current datasets against patterns identified in historical datasets. In an embodiment, the current datasets and the historical datasets were received by the computer system 995 in the past. That is, the current datasets can be previously received datasets and need not be recently received datasets. In an embodiment, the current datasets are recently received datasets and the historical datasets are datasets that were received before the current datasets were received. In an embodiment, the current datasets and the historical datasets are received at the same time. In such an embodiment, the computer system 995 may receive the datasets and separate the datasets according to time period (e.g., separate the datasets into datasets of transactions associated with a first time period and datasets of transactions associated with a second time period, where the second time period comes after the first time period). In an embodiment, the computer system 995 receives datasets of transactions associated with multiple tax jurisdictions and the computer system 995 separates the datasets according to tax jurisdiction. Patterns may be identified per tax jurisdiction. In an embodiment, the computer system 995 parses and extracts dataset values from datasets.

As an example, the seller 993 may be a burger company operating in a particular state of the United States of America. The state may be considered as a tax jurisdiction 981 that has its own tax rules. The burger company may introduce a new type of burger, and based on the ingredients of the new burger and the state's specific tax rules, assign a particular tax code (a code that indicates the category of an item/product/service for tax remittance purposes) to the new burger in the OSP 998. The OSP 998 may begin receiving datasets of transactions for sales of the new burger from a multitude of sales locations (e.g., multiple franchise locaitons) of the burger company. A user 992 of the OSP 998 may have configured the OSP 998 to monitor the tax code parameter for discontinuities, particularly if there is any change in taxability of the item. Thus, the OSP 998 may identify patterns in datasets of transactions associated with the burger company and the state, and store these patterns. For example, the OSP 998 may identify a pattern that the tax code assigned to the new burger has a first particular value.

Subsequently, the burger company may themselves change the taxability code assigned to this new burger due to a new state law. The OSP 998 may detect this as a discontinuity (e.g., due to receiving datasets having a different taxability code). However, this discontinuity affects all of the burger company's locations in the state at the same time (it is a pervasive discontinuity) so it is determined to be a legitimate discontinuity that does not warrant a notification. As a result, the OSP 998 does not transmit a notification regarding the discontinuity in this case. The OSP 998 may identify a new pattern that the taxability code assigned to the new burger has a second particular value (that is different from the first particular value).

Subsequently, one of the burger company's locations may begin transmitting datasets with the old taxability code (e.g., the first particular value) or a different taxability code than the recently configured one (e.g., a value that is different from the second particular value), which changes the taxability of the new burger (e.g., impacting whether and/or how much tax is remitted), and this particular location is the only location that transmits datasets with the old/different taxability code. Upon receiving such datasets, the OSP 998 may detect a discontinuity based on comparing the taxability code included in the received datasets against the stored pattern. In response, the OSP 998 may begin generating an error for the transactions so that invoicing cannot be completed (e.g., because the user 992 may have previously configured the OSP 998 to perform such reactive action when a discontinuity is detected). Other possible reactive action could include transmitting a notification to the user 992 or an agent of the seller 993 but not erroring out the transaction, only transmitting a notification to certain administrators/users, logging information regarding the discontinuity at the OSP 998 but not transmitting a notification, modifying the datasets to have what is considered to be the appropriate taxability code (e.g., the second particular value), etc.

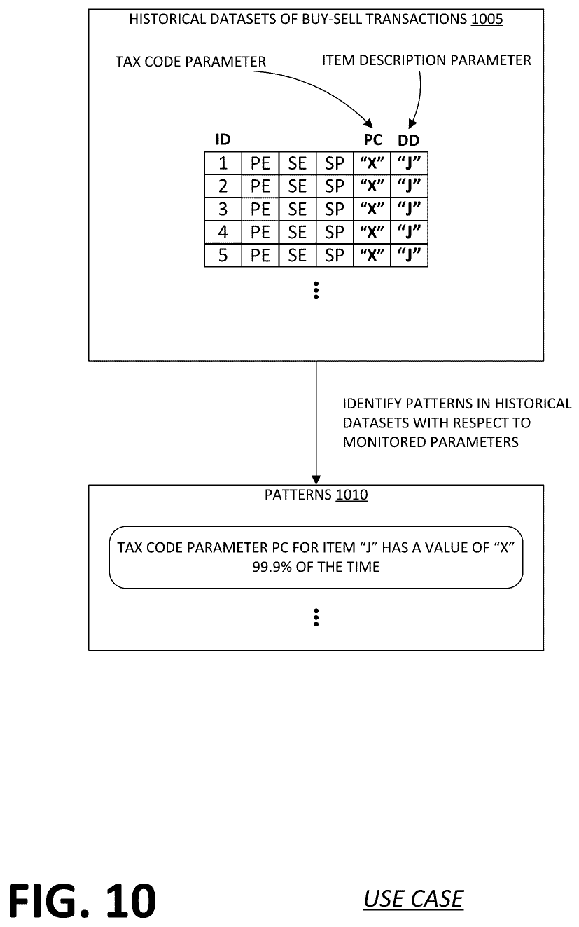

FIG. 10 is a diagram showing an example of identifying patterns in historical datasets, in a use case where the datasets represent buy-sell transactions, according to some embodiments.

As shown in the diagram, the historical datasets 1005 may include multiple datasets having parameters ID, PE, SE, SP, PC, and DD. Five datasets are shown in the diagram, but there may be additional datasets as indicated by the dot-dot-dot. Each dataset may have a unique ID parameter value. For example, the first dataset has an ID parameter value of “1,” the second dataset has an ID parameter value of “2,” and so on. Also, in this example, it is assumed that 99.9% of the datasets, including the five datasets that are shown in the diagram, have a PC parameter value of “X” and a DD parameter value of “J.” The PC parameter may be a tax code parameter and the DD parameter may be an item description parameter. The values of the other parameters are not important for understanding how patterns 1010 are identified in the context of this particular example so their actual values are not shown in the diagram.

A computer system (e.g., the computer system 995) may identify patterns 1010 in the historical datasets 1005 with respect to monitored parameter(s) by analyzing the historical datasets 1005. In this example, it is assumed that parameter PC and parameter DD are parameters being monitored and that the computer system identifies a pattern that the tax code parameter PC for item “J” (item having a description of “J”) has a value of “X” 99.9% of the time. The computer system may then store this pattern so that it can be used for detecting discontinuities. The computer system may identify additional patterns as indicated by the dot-dot-dot.

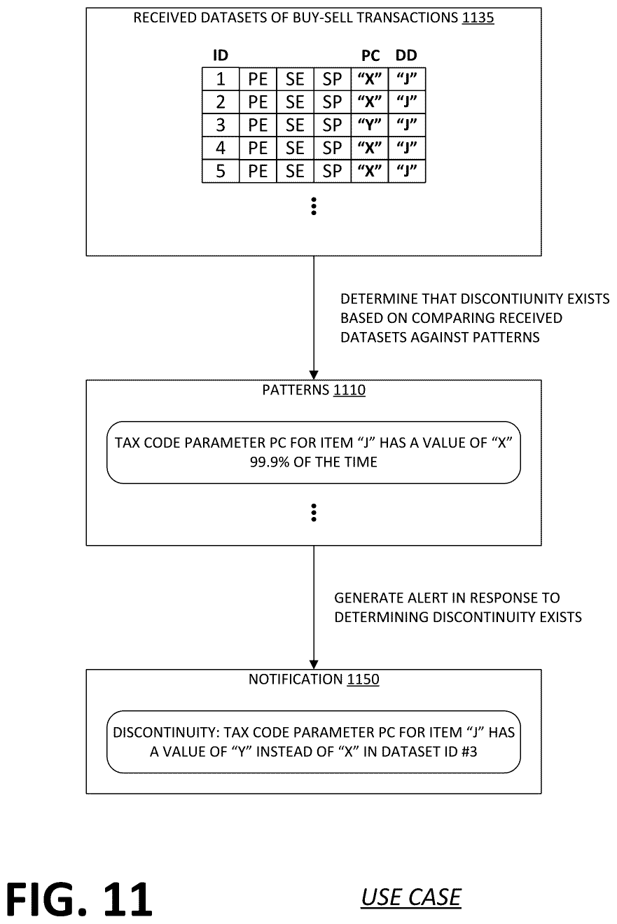

FIG. 11 is a diagram showing an example of determining that a discontinuity exists in received datasets, in a use case where the datasets represent buy-sell transactions, according to some embodiments.

As shown in the diagram, the received datasets 1135 may include multiple datasets having parameters ID, PE, SE, SP, PC, and DD. Five datasets are shown in the diagram, but there may be additional datasets as indicated by the dot-dot-dot. Each dataset may have a unique ID parameter value. For example, the first dataset has an ID parameter value of “1,” the second dataset has an ID parameter value of “2,” and so on. For sake of simplicity, the received datasets 1135 have the same ID parameter values as the historical datasets 1005 shown in FIG. 10, but it should be appreciated that the received datasets 1135 may have different ID parameter values from the ID parameter values of the historical datasets 1005. Also, in this example, the dataset having an ID parameter value of “3” has a PC parameter value of “Y” and a DD parameter value of “J,” while the other datasets shown in the diagram have a PC parameter value of “X” and a DD parameter value of “J.” The PC parameter may be a tax code parameter and the DD parameter may be an item description parameter.

A computing system (e.g., computing system 195) may determine that a discontinuity exists in the received datasets 1135 based on comparing the PC parameter values and the DD parameter values of the received datasets 1135 against the patterns 1110 including the pattern indicating that the tax code parameter PC for item “J” has a value of “X” 99.9% of the time. In this example, the computer system determines that the discontinuity exists because the value of the PC parameter of the dataset having ID parameter value of “3” has a value of “Y” instead of “X,” which deviates from the pattern that parameter PC has a value of “X” 99.9% of the time when the DD parameter has a value of “J.”

Responsive to determining that the discontinuity exists, the computer system may transmit a notification 1150 indicating there is a discontinuity in the received datasets 1135 because the tax code parameter PC for item “J” has a value of “Y” instead of “X” in dataset ID #3.

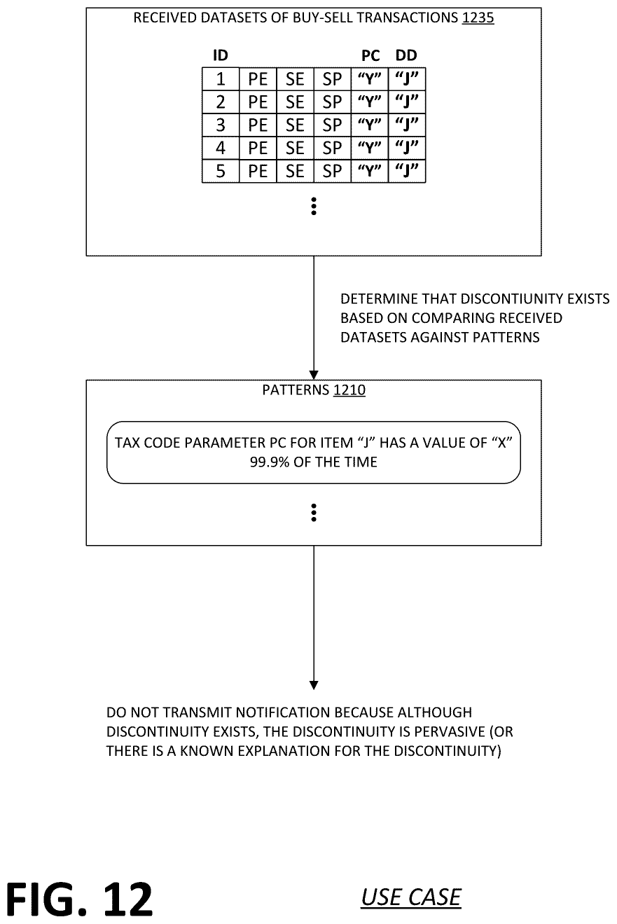

FIG. 12 is a diagram showing an example of determining that a discontinuity exists in received datasets but not transmitting a notification because the discontinuity is pervasive, in a use case where the datasets represent buy-sell transactions, according to some embodiments.

As shown in the diagram, the received datasets 1235 may include multiple datasets having parameters ID, PE, SE, SP, PC, and DD. Five datasets are shown in the diagram, but there may be additional datasets as indicated by the dot-dot-dot. Each dataset may have a unique ID parameter value. For example, the first dataset has an ID parameter value of “1,” the second dataset has an ID parameter value of “2,” and so on. For sake of simplicity, the received datasets 1235 have the same ID parameter values as the historical datasets 1005 and the received datasets 1135 shown in FIG. 10 and FIG. 11, respectively, but it should be appreciated that the received datasets 1235 may have different ID parameter values from the ID parameter values of the historical datasets 1005 and the received datasets 1135. Also, it is assumed in this example that all of the received datasets 1235 or a vast majority of the received datasets 1235 have a PC parameter value of “Y” and a DD parameter value of “J.”

In an embodiment, even if a computing system (e.g., computing system 195) determines that a discontinuity exists in the received dataset 1235, the computing system does not transmit a notification regarding the discontinuity if the discontinuity is pervasive (e.g. it affects many datasets)-what is considered to be “pervasive” may vary depending on the particular implementation. A discontinuity being pervasive may indicate that the discontinuity is a result of an intentional change/action, and thus does not warrant notification.

For example, the computing system may determine that a discontinuity exists in the received datasets 1235 based on comparing the PC parameter values and DD parameter values of the received datasets 1235 against the patterns 1210 including the pattern indicating that the tax code parameter PC for item “J” has a value of “X” 99.9% of the time. However, the computer system does not transmit a notification regarding the discontinuity in this case because, although a discontinuity exists, the discontinuity is pervasive (there are many datasets having a PC parameter value of “Y” (instead of “X”) and DD parameter value of “J”) or there is some other explanation for the discontinuity (e.g., the values of other parameters of the datasets suggest that “Y” is the appropriate value for the PC parameter or the digital rules indicate that “Y” is the appropriate value for the PC parameter).

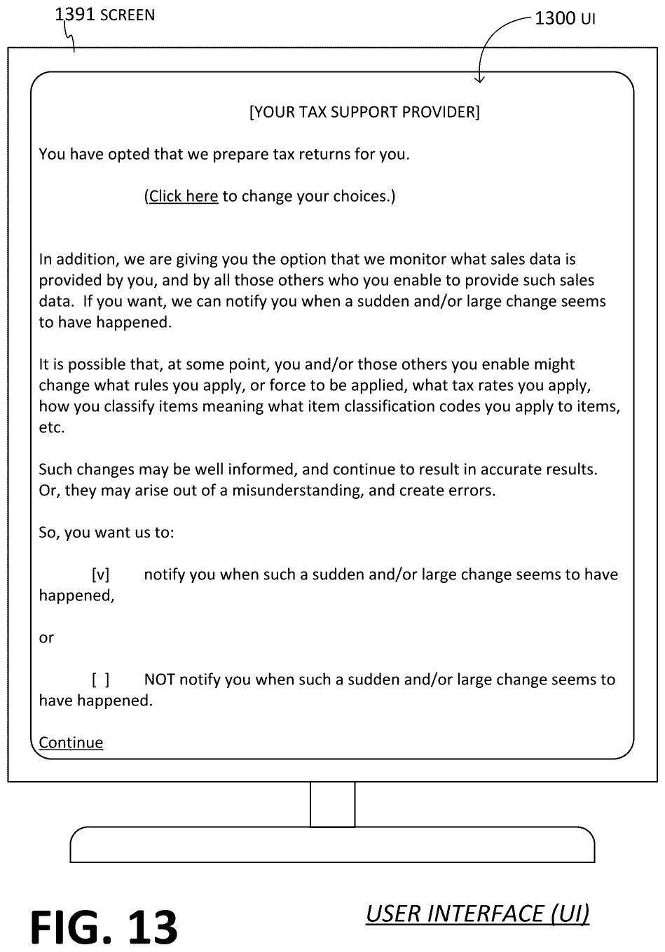

FIG. 13 is a diagram showing a sample UI shown on a screen, according to some embodiments. The screen 1391 could be the screen 991 of FIG. 9. The UI 1300 may be displayed on the screen 1391 to allow a user to choose to be notified when a sudden/large change occurs (i.e., a discontinuity exists) in datasets of transactions associated with a seller (i.e., sales data). In particular, the UI 1300 presents an option for the user to choose to be notified or not notified when a sudden/large change occurs in datasets.

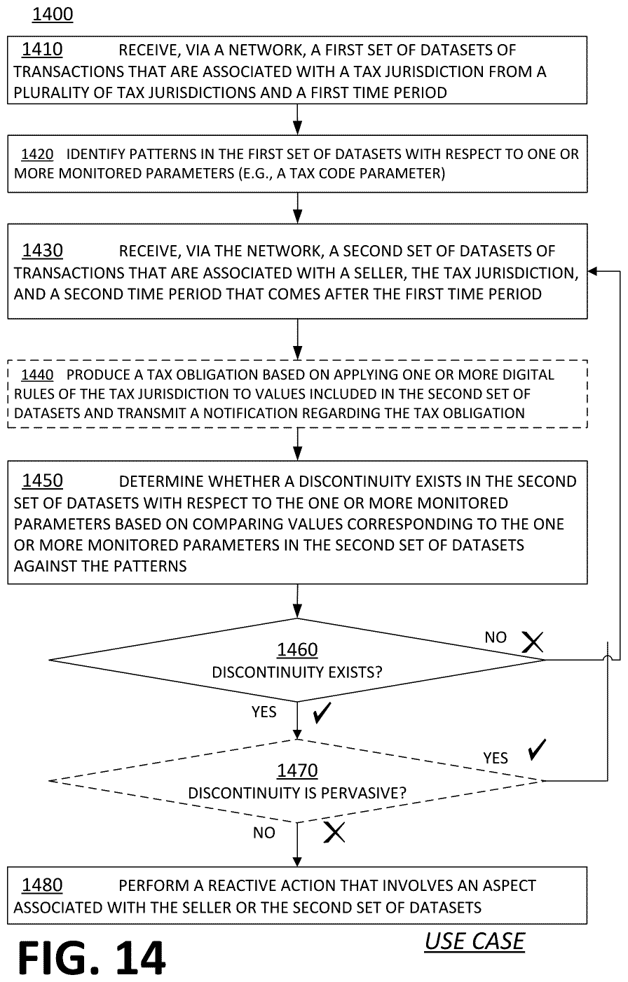

FIG. 14 is a flowchart for a method to monitor for discontinuities in datasets, in a use case where the datasets represent buy-sell transactions, according to some embodiments. The method 1400 may be performed by a computer system, such as the sample computer system 995 of FIG. 9, the computer system 890 or 895 of FIG. 8, or another suitable computer system. The computer system performing the method 1400 may be part of an OSP.

At operation 1410, the computer system receives, via a network, a first set of datasets of transactions that are associated with a tax jurisdiction from a plurality of tax jurisdiction and a first time period. In an embodiment, the first set of datasets includes datasets of transactions associated with a particular seller (e.g., the seller associated with the transactions represented by the second set of datasets mentioned in operation 1430). In an embodiment, the first set of datasets further includes datasets of transactions associated with sellers other than the particular seller.

At operation 1420, the computer system identifies patterns in the first set of datasets with respect to one or more monitored parameters. One of the monitored parameters may be a tax code parameter. In an embodiment, the one or more monitored parameters are configurable by a user of the OSP. In an embodiment, the patterns include statistics for a monitored parameter from the one or more monitored parameters. In an embodiment, the statistics for the monitored parameter include one or more of: a mode value for the monitored parameter, an average value for the monitored parameter, a standard deviation for the monitored parameter, a percentage of datasets in which the monitored parameter has a particular value, a percentage of datasets in which the monitored parameter has a particular value when a description parameter has a particular description value, and a trend of values for the monitored parameter. In an embodiment, the identifying the patterns in the first set of datasets comprises training a discontinuity machine learning model using the first set of datasets to learn the patterns, wherein the determining whether the discontinuity exists in the second set of datasets comprises applying the discontinuity model to the second set of datasets.

At operation 1430, the computer system receives, via the network, a second set of datasets of transactions that are associated with a seller, the tax jurisdiction, and a second time period that comes after the first time period.

In an embodiment, the OSP maintains digital rules of the tax jurisdiction that correspond to tax rules of the tax jurisdiction.

In an embodiment, at operation 1440, the computer system produces a tax obligation based on applying one or more digital rules of the tax jurisdiction to values included in the second set of datasets and transmits a notification regarding the tax obligation (e.g., to an agent of the seller).

At operation 1450, the computer system determines whether a discontinuity exists in the second set of datasets with respect to the one or more monitored parameters based on comparing values corresponding to the one or more monitored parameters in the second set of datasets against the patterns.

At decision block 1460, if a discontinuity does not exist in the second set of datasets with respect to the one or more parameters, the method proceeds back to operation 1430 to receive additional datasets of transactions associated with the seller and the tax jurisdiction. Otherwise, if a discontinuity exists in the second set of datasets with respect to the one or more parameters, the method proceeds to operation 1470 (optional) or operation 1480.

In an embodiment, the computer system determines whether the discontinuity is pervasive. At decision block 1470, if the discontinuity is pervasive, then the method proceeds back to operation 1430 to receive additional datasets of transactions associated with the seller and the tax jurisdiction (e.g., without performing a reactive action). Otherwise, if the discontinuity is not pervasive, then the method proceeds to operation 1480.

At operation 1480, the computer system performs a reactive action that involves an aspect associated with the seller or the second set of datasets. In an embodiment, the reactive action is configurable by a user of the OSP. In an embodiment, the reactive action includes one or more of: transmitting a notification regarding the discontinuity to an agent of the seller, generating a processing error for a dataset included in the second set of datasets, logging information regarding the discontinuity for viewing by an agent of the seller, and modifying a dataset included in the second set of datasets. In an embodiment, the reactive action includes determining whether the tax rules of the tax jurisdiction have changed and responsive to determining that the tax rules of the tax jurisdiction have changed, updating the digital rules of the tax jurisdiction maintained by the OSP.

In an embodiment, the computer system generates a UI that allows a user of the OSP to request that the OSP monitor for discontinuities in datasets of transactions associated with the seller and causes the user interface to be displayed on a screen of a device operated by the user.

### General

Software aspects of embodiments may include instructions for processors, methods of operation, datasets, interfaces, user interfaces (UIs), applications, Application Programming Interfaces (APIs), connectors, and the like.

Software aspects or modules of embodiments can be hosted on any suitable machine, anywhere. For example, such software aspects can be hosted on a computer system, a desktop computer, an on-location server, a machine that is located remotely to where other processes are executed, such as in the cloud or on the premises of a provider, a memory of such, and so on. The software can be accessible by a user via a browser, a UI, an API, etc. Depending on where hosted, some software components or modules can be considered a client, etc.

Importantly, although the operational and or functional descriptions of this document are understandable by the human mind, they are not abstract ideas of the operations/functions divorced from computational implementation of those operations/functions. Rather, the operations/functions represent a specification for complex computational machines or other means. As discussed in detail elsewhere in this document, each time the operational/functional language must be read in its proper technological context, i.e., as concrete specifications for physical implementations. Far from being understood as an abstract idea, it can be recognized that a functional/operational technical description as a humanly-understandable representation of one or more almost unimaginably complex and time sequenced hardware instantiations.

Moreover, the methods, algorithms, operations, functions and acts described in this document are not necessarily inherently associated with any particular logic device or other apparatus. Rather, they are advantageously implemented by programs for use by any of the devices or systems described in this document. These algorithms are not necessarily purely mathematical, and are configured to address challenges particular to the problem solved, as will be apparent to a person skilled in the art.

This detailed description may include flowcharts, display images, algorithms, and symbolic representations of program operations within at least one computer readable medium. An economy may be achieved in that a single set of flowcharts can be used to describe both programs, and also methods. So, while flowcharts describe methods in terms of boxes, they may also concurrently describe programs.

In the methods described above, each operation can be performed as an affirmative step of doing, or causing to happen, what is written that can take place. Such doing or causing to happen can be by the whole system or device, or just one or more components of it. In addition, the order of operations is not constrained to what is shown, and different orders may be possible according to different embodiments. Examples of such alternate orderings may include overlapping, interleaved, interrupted, reordered, incremental, preparatory, supplemental, simultaneous, reverse, or other variant orderings, unless context dictates otherwise. Moreover, in certain embodiments, new operations may be added, or individual operations may be modified or deleted. The added operations can be, for example, from what is mentioned while primarily describing a different system, apparatus, device or method.

At least one of the methods described herein, when implemented by a computer, can be performed at the rate of at least 10 times per second.

This description includes one or more examples, but that does not limit how the invention may be practiced. Indeed, examples or embodiments of the invention may be practiced according to what is described, or yet differently, and also in conjunction with other present or future technologies. Other embodiments include combinations and sub-combinations of features described or shown in the drawings herein, including for example, embodiments that are equivalent to: providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, feature or features can refer to the structures and/or functions of an apparatus, article of manufacture or system, and/or the steps, acts, or modalities of a method.

A person skilled in the art will be able to practice the present invention in view of this description, which is to be taken as a whole. Details have been included to provide a thorough understanding. In other instances, well-known aspects have not been described, in order to not obscure unnecessarily the present invention. Plus, any reference to any prior art in this description is not, and should not be taken as, an acknowledgement or any form of suggestion that this prior art forms parts of the common general knowledge in any country.

Some technologies or techniques described in this document may be known. Even then, however, it does not necessarily follow that it is known to apply such technologies or techniques as described in this document, or for the purposes described in this document.

A number of embodiments are possible, each including various combinations of elements. When one or more of the appended drawings—which are part of this specification—are taken together, they may present some embodiments with their elements in a manner so compact that these embodiments can be surveyed quickly. This is true even if these elements are described individually extensively in this text, and these elements are only optional in other embodiments.

In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the claimed invention.

In this document, the phrases “constructed to”, “adapted to” and/or “configured to” denote one or more actual states of construction, adaptation and/or configuration that is fundamentally tied to physical characteristics of the element or feature preceding these phrases and, as such, reach well beyond merely describing an intended use. Any such elements or features can be implemented in a number of ways, as will be apparent to a person skilled in the art after reviewing the present disclosure, beyond any examples shown in this document.

Parent patent applications: Any and all parent, grandparent, great-grandparent, etc. patent applications, whether mentioned in this document or in an Application Data Sheet (“ADS”) of this patent application, are hereby incorporated by reference herein as originally disclosed, including any priority claims made in those applications and any material incorporated by reference, to the extent such subject matter is not inconsistent herewith.

Reference numerals: In this description a single reference numeral may be used consistently to denote a single item, aspect, component, or process. Moreover, a further effort may have been made in the preparation of this description to use similar though not identical reference numerals to denote other versions or embodiments of an item, aspect, component or process that are identical or at least similar or related. Where made, such a further effort was not required, but was nevertheless made gratuitously so as to accelerate comprehension by the reader. Even where made in this document, such a further effort might not have been made completely consistently for all of the versions or embodiments that are made possible by this description. Accordingly, the description controls in defining an item, aspect, component or process, rather than its reference numeral. Any similarity in reference numerals may be used to infer a similarity in the text, but not to confuse aspects where the text or other context indicates otherwise.

The claims of this document may define certain combinations and sub-combinations of elements, features and acts or operations, which are regarded as novel and non-obvious. The claims may also include elements, features and acts or operations that are equivalent to what is explicitly mentioned. Additional claims for other such combinations and sub-combinations may be presented in this or a related document. These claims are intended to encompass within their scope all changes and modifications that are within the true spirit and scope of the subject matter described herein.

The terms used herein, including in the claims, are generally intended as “open” terms. For example, the term “including” should be interpreted as “including but not limited to,” the term “having” should be interpreted as “having at least,” etc. If a specific number is ascribed to a claim recitation, this number is a minimum but not a maximum unless stated otherwise. For example, where a claim recites “a” component or “an” item, it means that the claim can have one or more of this component or this item.

In construing the claims of this document, 35 U.S.C. § 112(f) is invoked by the inventor(s) only when the words “means for” or “steps for” are expressly used in the claims. Accordingly, if these words are not used in a claim, then that claim is not intended to be construed by the inventor(s) in accordance with 35 U.S.C. § 112(f).

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method performed by a computer system of an online software platform (OSP), the method comprising:
receiving, via a network, a first set of datasets of relationship instances that are associated with a domain from a plurality of domains and a first time period;
identifying patterns in the first set of datasets with respect to one or more monitored parameters;
receiving, via the network, a second set of datasets of relationship instances that are associated with an entity, the domain, and a second time period that comes after the first time period;
determining whether a discontinuity exists in the second set of datasets with respect to the one or more monitored parameters based on comparing values corresponding to the one or more monitored parameters in the second set of datasets against the patterns; and
responsive to determining that the discontinuity exists in the second set of datasets with respect to the one or more parameters, performing a reactive action that involves an aspect associated with the entity or the second set of datasets.

2. The method of claim 1, wherein the patterns include statistics for a monitored parameter from the one or more monitored parameters.

3. The method of claim 2, wherein the statistics for the monitored parameter include one or more of: a mode value for the monitored parameter, an average value for the monitored parameter, a standard deviation for the monitored parameter, a percentage of datasets in which the monitored parameter has a particular value, a percentage of datasets in which the monitored parameter has a particular value when a description parameter has a particular description value, and a trend of values for the monitored parameter.

4. The method of claim 1, wherein the identifying the patterns in the first set of datasets comprises training a discontinuity machine learning model using the first set of datasets to learn the patterns, wherein the determining whether the discontinuity exists in the second set of datasets comprises applying the discontinuity model to the second set of datasets.

5. The method of claim 1, wherein the reactive action includes one or more of: transmitting a notification regarding the discontinuity to an agent of the entity, generating a processing error for a dataset included in the second set of datasets, logging information regarding the discontinuity for viewing by an agent of the entity, and modifying a dataset included in the second set of datasets.

6. The method of claim 1, wherein the OSP maintains digital rules of the domain that correspond to domain rules of the domain.

7. The method of claim 6, further comprising:
determining a resource based on applying one or more of the digital rules of the domain to values included in the second set of datasets; and
transmitting a notification regarding the resource to an agent of the entity.

8. The method of claim 6, wherein the reactive action includes determining whether the domain rules of the domain have changed and responsive to determining that the domain rules of the domain have changed, updating the digital rules of the domain maintained by the OSP.

9. The method of claim 1, wherein the reactive action is configurable by a user of the OSP.

10. The method of claim 1, wherein the one or more monitored parameters are configurable by a user of the OSP.

11. The method of claim 1, wherein the first set of datasets includes datasets of relationship instances associated with the entity.

12. The method of claim 11, wherein the first set of datasets further includes datasets of relationship instances associated with entities other than the entity.

13. The method of claim 1, further comprising:
generating a user interface that allows a user of the OSP to request that the OSP detect discontinuities in datasets of relationship instances associated with the entity; and
causing the user interface to be displayed on a screen of a device operated by the user.

14. The method of claim 1, further comprising:
receiving, via the network, a third set of datasets of relationship instances that are associated with the entity, the domain, and a third time period that comes after the first time period;
determining whether a discontinuity exists in the third set of datasets with respect to the one or more monitored parameters based on comparing values corresponding to the one or more monitored parameters in the third set of datasets against the patterns; and
responsive to determining that the discontinuity exists in the third set of datasets with respect to the one or more parameters but that the discontinuity that exists in the third set of datasets is pervasive, refraining from performing a reactive action.

15-42. (canceled)
